(19) United States
(12) Patent Application Publication
(10) Pub. No.: US 2024/0125409 A1
(43) Pub. Date: Apr. 18, 2024

(54) TRAPEZE CONDUIT SUPPORT SYSTEM

(71) Applicant: Eaton Intelligent Power Limited, Dublin (IE)

(72) Inventor: Martin Lee Witherbee, Godfrey, IL (US)

(73) Assignee: Eaton Intelligent Power Limited, Dublin (IE)

(21) Appl. No.: 18/306,831

(22) Filed: Apr. 25, 2023

Related U.S. Application Data
(63) Continuation of application No. 16/191,099, filed on Nov. 14, 2018, now abandoned.
(60) Provisional application No. 62/736,422, filed on Sep. 25, 2018.

(51) Int. Cl. F16L 3/10; F16L 3/223

(52) U.S. Cl. CPC F16L 3/1091; F16L 3/2235

(57) ABSTRACT

A support bracket for a hanger assembly that supports one or more non-structural components in a building comprises a web having opposite upper and lower edge margins and opposite left and right edge margins. The web defines at least one non-structural component opening configured to receive and support one of the non-structural components. The at least one non-structural component opening having a closed shape. A first flange extends from the upper edge margin of the web in a first direction and is configured to be attached to at least one support rod. A second flange extends from the lower edge margin of the web in a second direction opposite the first direction. The left and right edge margins of the web define partial openings. Each of the partial openings having an open shape that is a segment of the closed shape of the at least one non-structural component opening.

### CROSS-REFERENCE TO RELATED APPLICATION

This application is a continuation of U.S. Nonprovisional patent application Ser. No. 16/191,099, filed Nov. 14, 2018, which claims the benefit of U.S. Provisional Application No. 62/736,422, filed Sep. 25, 2018, the entirety of which is hereby incorporated by reference.

### FIELD OF THE DISCLOSURE

The present disclosure generally relates to a hanger assembly, and more particularly to a support bracket of a hanger assembly for supporting non-structural components in a building.

### BACKGROUND

There are many different ways to support non-structural components in a building. Examples of non-structural components in a building include, but are not limited to, pipes, conduits, ducts, etc. These non-structural components often contain supporting wiring, plumbing, or mechanical components for various different systems in a building such as air conditioning or ventilation systems.

### SUMMARY

In one aspect, a support bracket for a hanger assembly that supports one or more non-structural components in a building comprises a web having opposite upper and lower edge margins, opposite left and right edge margins, and a length extending between the left and right edge margins. The web defines at least one non-structural component opening configured to receive and support one of the non-structural components. The at least one non-structural component opening having a closed shape. A first flange extends from the upper edge margin of the web in a first direction and is configured to be attached to at least one support rod. A second flange extends from the lower edge margin of the web in a second direction opposite the first direction. The left and right edge margins of the web define partial openings. Each of the partial openings having an open shape that is a segment of the closed shape of the at least one non-structural component opening.

In another aspect, a support bracket for a hanger assembly that supports one or more non-structural components in a building comprises a web having opposite upper and lower edge margins, opposite left and right edge margins, and a length extending between the left and right edge margins. The web defines at least one non-structural component opening configured to receive and support one of the non-structural components. A first flange extends from the upper edge margin of the web in a first direction. The first flange defines left and right support rod openings adjacent the respective left and right edge margins of the web. The left and right support rod openings are configured to receive respective left and right support rods. A second flange extends from the lower edge margin of the web in a second direction opposite the first direction. At least one of the first flange and the second flange defines accessory attachment openings spaced apart from one another along the respective one of the first and second flange.

### BRIEF DESCRIPTION OF THE DRAWINGS

FIG. 1 is a perspective of one embodiment of a hanger assembly according to the teachings of the present disclosure;

FIG. 2 is a perspective of one embodiment of a support bracket for the hanger assembly;

FIG. 3 is a side view thereof,

FIG. 4 is a perspective of another embodiment of a support bracket;

FIG. 5 is a perspective of another embodiment of a support bracket;

FIG. 6 is a perspective of another embodiment of a hanger assembly;

FIG. 7 is an enlarged view thereof;

FIG. 8 is a perspective of another embodiment of a hanger assembly;

FIG. 9 is a perspective of another embodiment of a hanger assembly;

FIG. 10 is a front view of another embodiment of a hanger assembly;

FIGS. 11A-11D are enlarged perspective views of the hanger assembly of FIG. 1 showing the steps of attaching a support rod to the support bracket;

FIG. 12 is an enlarged view of a support bracket with one embodiment of a rod coupler for connecting the support bracket to the support rod;

FIG. 13 is an enlarged view of a support bracket with another embodiment of a rod coupler for connecting the support bracket to the support rod;

FIG. 14 is an enlarged view of a support bracket with another embodiment of a rod coupler for connecting the support bracket to the support rod;

FIG. 15 is an enlarged view of a support bracket with another embodiment of a rod coupler for connecting the support bracket to the support rod;

FIG. 16 is a perspective of another embodiment of a hanger assembly with another embodiment of a rod coupler for connecting the support bracket to the support rod;

FIG. 17 is an enlarged view thereof;

FIG. 18 is a perspective of another embodiment of a hanger assembly with another embodiment of a rod coupler for connecting the support bracket to the support rod;

FIG. 19 is an enlarged view thereof,

FIG. 20 is a perspective of another embodiment of a hanger assembly with another embodiment of a rod coupler for connecting the support bracket to the support rod;

FIG. 21 is a perspective of a clip of the rod coupler of FIG. 20;

FIG. 22 is an enlarged view of FIG. 20;

FIG. 23 is a perspective of one embodiment of a coupling device for connecting support brackets together;

FIG. 24 is an enlarged perspective of the coupling device of FIG. 23 connecting two support brackets together;

FIG. 25 is a perspective of another embodiment of a coupling device for connecting support brackets together;

FIG. 26 is an enlarged perspective of two coupling devices of FIG. 25 connecting two support brackets together in a first configuration;

FIG. 27 is an enlarged perspective of two coupling devices of FIG. 25 connecting two support brackets together in a second configuration;

FIG. 28 is a perspective of another embodiment of a coupling device for connecting support brackets together;

FIG. 29 is an enlarged perspective of the coupling device of FIG. 28 connecting two support brackets together in a first configuration;

FIG. 30 is an enlarged perspective of the coupling device of FIG. 28 connecting two support brackets together in a second configuration;

FIG. 31 is a perspective of another embodiment of a coupling device for connecting support brackets together;

FIG. 32 is a perspective of another embodiment of a hanger assembly that includes seismic bracing or restraints attached to the support bracket and one embodiment of a reinforcement brace attached to the support bracket;

FIG. 33 is an enlarged view thereof;

FIG. 34 is a rear view of FIG. 32;

FIG. 35 is a perspective of the reinforcement brace of FIG. 32;

FIG. 36 is a perspective of another embodiment of a hanger assembly that includes seismic bracing or restraints attached to the support bracket and another embodiment of a reinforcement brace attached to the support bracket;

FIG. 37 is an enlarged view thereof,

FIG. 38 is a rear view of FIG. 36;

FIG. 39 is a perspective of the reinforcement brace of FIG. 36;

FIG. 40 is a front perspective of another embodiment of a reinforcement brace for a support bracket;

FIG. 41 is a rear perspective thereof;

FIG. 42 is a front perspective of the reinforcement brace of FIG. 40 attached to a support bracket;

FIG. 43 is a rear perspective thereof;

FIG. 44 is a perspective of another embodiment of a reinforcement brace for a support bracket;

FIG. 45 is a front perspective of the reinforcement brace of FIG. 44 attached to a support bracket;

FIG. 46 is a rear perspective thereof;

FIG. 47 is a perspective of another embodiment of a reinforcement brace for a support bracket;

FIG. 48 is a front perspective of the reinforcement brace of FIG. 47 attached to a support bracket;

FIG. 49 is a rear perspective thereof;

FIG. 50 is a perspective of another embodiment of a reinforcement brace for a support bracket;

FIG. 51 is a front perspective of the reinforcement brace of FIG. 50 attached to a support bracket;

FIG. 52 is a rear perspective thereof;

FIG. 53 is a perspective of another embodiment of a reinforcement brace for a support bracket;

FIG. 54 is a perspective of the reinforcement brace of FIG. 53 attached to a front side of a support bracket;

FIG. 55 is a perspective of a variation of the reinforcement brace of FIG. 53 attached to a rear side of the support bracket;

FIG. 56 is a perspective of another embodiment of a reinforcement brace for a support bracket;

FIG. 57 is a rear perspective of the reinforcement brace of FIG. 56 attached to a support bracket;

FIG. 58 is a perspective of another embodiment of a reinforcement brace for a support bracket;

FIG. 59 is a rear perspective of the reinforcement brace of FIG. 58 attached to a support bracket; and

FIG. 60 is a front perspective thereof.

Corresponding reference characters indicate corresponding parts throughout the drawings.

### DETAILED DESCRIPTION OF THE DRAWINGS

Overall, the support brackets of the various embodiments described herein are used in hanger assembly for supporting one or more non-structural components to a structural component in a building. A structural component can be, but is not limited to, a beam, a floor, a joist, a column, a girder, a ceiling, or any other building structural element. The support brackets may be constructed for use in many different fields, industries, and applications, including, but not limited to, safety grating industry, spring steel fastener industry, cable trays and ladders, pipe hangers, solar industry, racks and runways, electrical enclosures, seismic industry, and rooftop supports. The various support brackets are each configured to be hung from the structural component with support rods and receive non-structural components therein. The support brackets can have a variety of different support rod connection configurations to simplify and reduce the time required to connect the support rod to the support bracket. Various different coupling devices can be used to connect adjacent support brackets together to provide flexibility in the hanger assembly and increase the number of non-structural components that can be supported by the hanger assembly. Moreover, various different reinforcement braces can be connected to the support brackets to strength the support brackets for use in seismic applications.

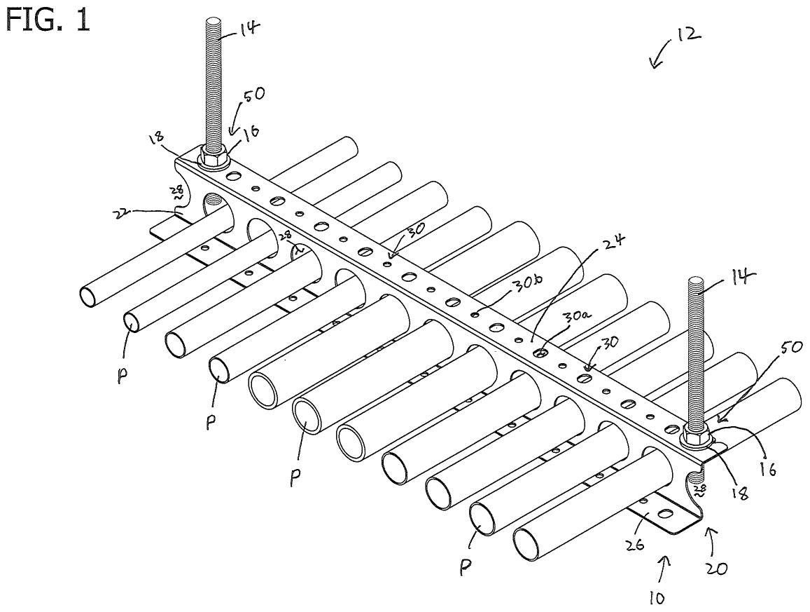

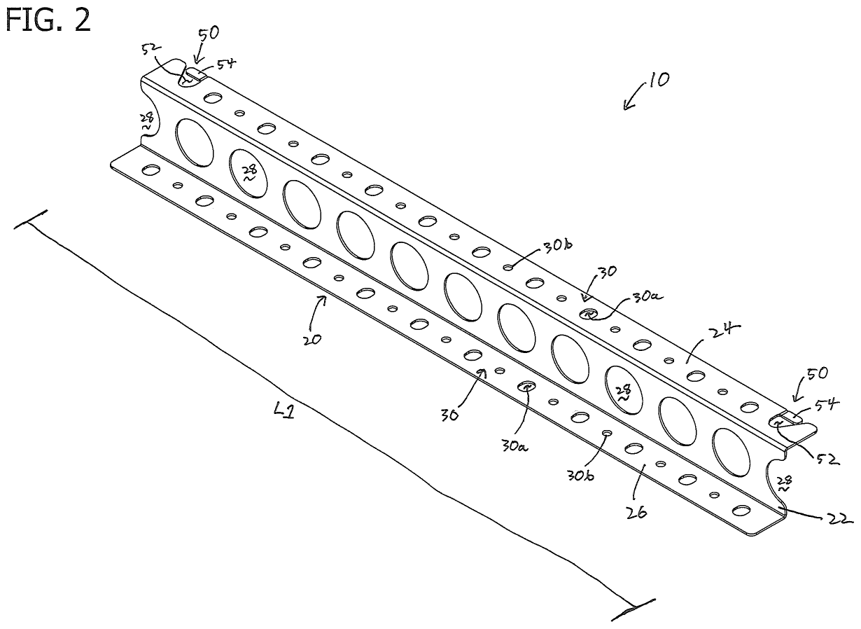

Referring to FIGS. 1-3, an embodiment of a support bracket for use in a hanger assembly (e.g., trapeze hanger assembly) constructed according to the teachings of the present disclosure is generally indicated at reference numeral 10. A hanger assembly, as generally indicated at 12, includes the support bracket 10, one or more support rods 14, and suitable fastener components connected to the support bracket or support rod, such as, but not limited to, nuts 16 and washers 18 used to connect the support bracket to the support rod. In the illustrated embodiment, the support rods 14 are fully threaded to threadably receive the nuts 16. The support bracket 10 has an elongate body, generally indicated at 20, having a length L1 extending between opposite ends of the body. The body 20 includes a central web 22, a upper flange 24 at an upper end of the web, and a lower flange 26 at a lower end of the web. The central web 22 and the top and lower flanges 24, 26 are generally planar. In the illustrated embodiment, the length L1 of the support bracket 10 may be about 24 inches (61 cm), however, the support bracket can have a length that is greater or less than 24 inches. For example, in other embodiments the support bracket 10 may have a length L1 of about 72 inches (1.8 m) or about 48 inches (1.2 m). The orientation of the support bracket 10 in FIGS. 1 and 2 provides the point of reference for the terms defining relative locations and positions of structures and components described herein, the terms including but not limited to “top,” “upper,” “bottom,” “lower,” “left,” “right,” “front,” and “rear,” as used throughout the present disclosure.

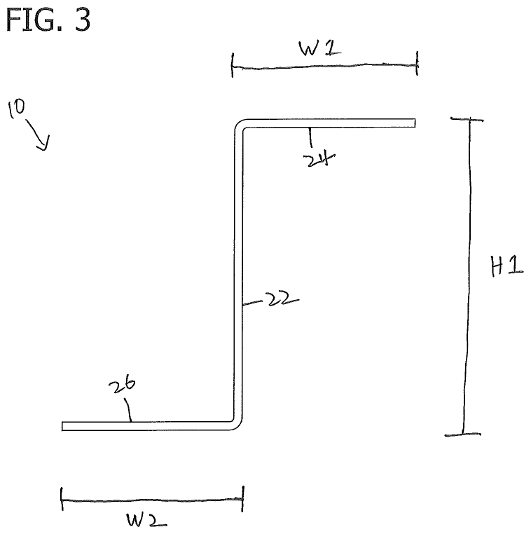

The web 22 is generally rectangular and has opposite upper and lower edge margins, opposite right and left edge margins, a front face, and a rear face. The web 22 has a length extending between the right and left edge margins that may be generally equal to the length L1 of the body 20. The web 22 is extends generally vertically and has a height H1 extending between the upper and lower edge margins. As shown in FIG. 3, the height H1 may generally correspond to the height of the support bracket 10. In the illustrated embodiment, the height H1 of the web 22 may be about 2¼ inches (5.7 cm), however, the web can have a height that is that are greater or less than 2¼ inches. The web 22 is configured to receive and support one or more non-structural components therein, such as a pipe P as shown in FIG. 1. The web 22 defines a plurality of non-structural component openings 28 spaced apart from one another along the web, each non-structural component opening sized and shaped to receive one non-structural component. In the illustrated embodiment, the non-structural component openings 28 are circular shaped with a diameter. In one embodiment, the diameter is about 1.4 inches (3.5 cm) so that the support bracket 10 can support non-structural components, such as pipes P, having an outer diameter of about 1.25 inches (3.2 cm) or less. The non-structural component opening 28 can have a diameter that is greater or less than 1.4 inches. In other embodiments, the non-structural component opening 28 may have other shapes such as a rectangle or oval shape.

The non-structural component openings 28 are sized and shaped to allow the non-structural component to be freely inserted therein. Thus, the support bracket 10 is able to support non-structural components without the use of clamps, as is generally used in the art. Each non-structural component opening 28 can have the same size and shape, as shown, or different sizes and shapes. Moreover, the non-structural component openings 28 can receive and support non-structural components of various sizes. For example, as shown in FIG. 1, the support bracket 10 of the hanger assembly 12 is supporting four different types (e.g., sizes) of conduits or pipes P, each having a different diameter. In the illustrated embodiment, the non-structural component openings 28 are longitudinally spaced apart along the length L1 of the web 22 and are substantially centered between the upper and lower edge margins of the web. For example, the non-structural component openings 28 can be spaced apart by about 2 inches (5 cm) on center, although other dimensions are within the scope of the present disclosure. In one or more embodiments, the non-structural component openings 28 may have other configurations. For example, one or more (including all) of the non-structural component openings 28 may be a different shape, such as square or rectangular. Moreover, the non-structural component openings 28 may be positioned between the upper and lower edge margins of the web 22 at location other than center. In the preferred embodiment, the opposite left and right edge margins of the web 22 each define a portion of a non-structural component opening 28, such has approximately half a non-structural component opening as shown, which can align with a non-structural component opening of an adjacent support bracket 10, described in more detail below. In other words, the web 22 defines at least one non-structural component opening 28 having a closed shape (e.g., the web fully encloses the opening). These fully enclosed non-structural component openings 28 are disposed interior of the left and right edge margins of the web 22. The opposite left and right edge margins of the web 22 define partial non-structural component openings 28, each of these openings having an opening shape (e.g., non-enclosed) that is a segment of the closed shape of the at least one non-structural component opening. In this manner, the partial or open non-structural component opening 28 at each end of the support bracket 10 can align with a portion or segment of the closed non-structural component openings of an adjacent support bracket, as described below.

The upper flange 24 extends from the upper edge margin of the web 22 to a free end. The upper flange 24 is generally rectangular and has opposite left and right edge margins, a top face and a bottom face. The upper flange 24 has a length extending between the right and left edge margins that is equal to the length L1 of the body 20. The upper flange 24 extends generally horizontally and is generally perpendicular to the web 22. In the illustrated embodiment, the upper flange 24 extends in a rearward direction (e.g., in the direction of the rear face of the web). In another embodiment, the upper flange 24 may extend in a forward direction (e.g., in the direction of the front face of the web 22). The upper flange 24 has a width W1 extending between the upper edge margin of the web 22 and free end of the upper flange. In one embodiment, the width W1 of the upper flange 24 is about 1.3 inches (3.3 cm), however, the upper flange can have a width that is greater or less than 1.3 inches.

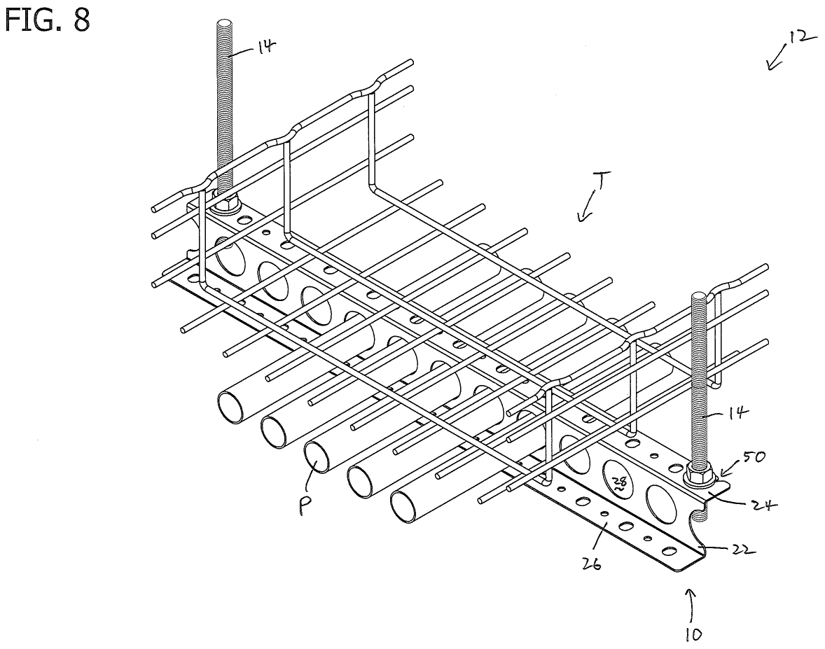

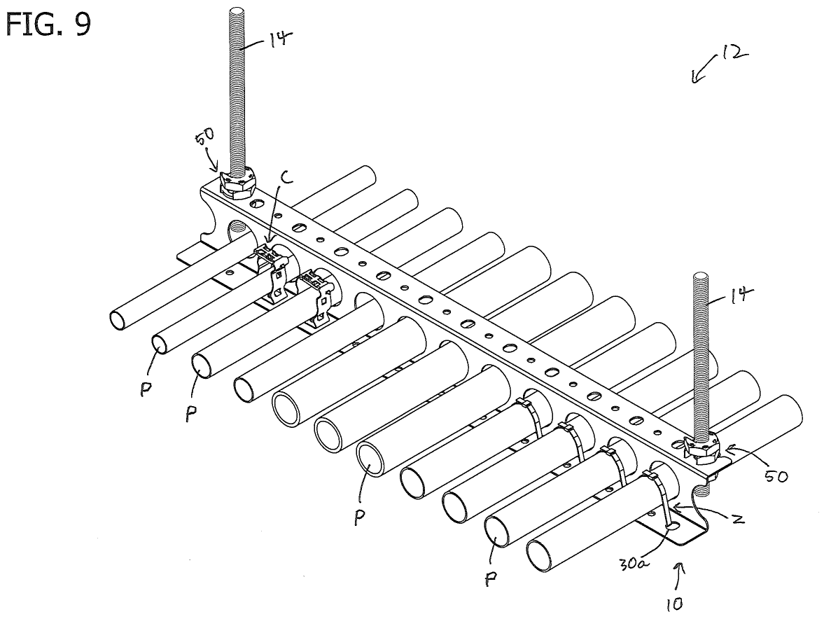

The upper flange 24 can define one or more accessory attachment openings 30. The accessory attachment openings 30 can have different configurations, such as a slot 30a and/or a circular opening 30b, and are configured to connect to various accessories that may be used with the hanger assembly 12 (e.g., receive fasteners to connect the accessories to the upper flange 24). In one embodiment, shown in FIG. 8, the accessory attachment openings 30 are used to secure a wire-cable tray T that is supported by the upper flange 26 of the support bracket. In another embodiment, shown in FIGS. 9 and 10, the accessory attachment openings 30 can receive zip-ties Z and/or various non-structural component clamps C to further secure the non-structural component, such as the pipe P, to the support bracket 10 and inhibit the non-structural component from moving relative to the support bracket. Other accessories can be connected to the support bracket 10. The slots 30a and holes 30b can be various sizes (e.g., areas). For example, the holes 30b can have a diameter of ¼ inch (6 mm), or a diameter of ½ inch (13 mm). In other words, some accessory attachment openings 30 (e.g., a first group) may have an area less than an area of other accessory attachment openings (e.g., a second group).

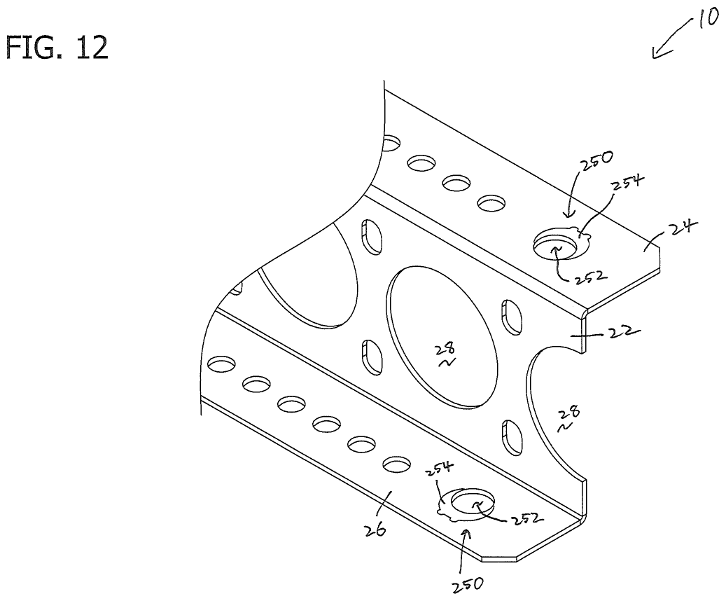

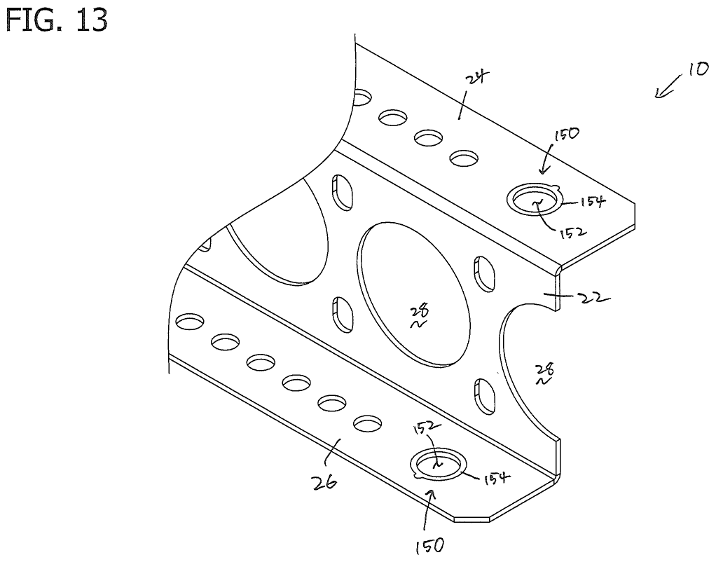

In the illustrated embodiment, the upper flange 24 defines a plurality of accessory attachment openings 30 spaced apart longitudinally along the length L1 of the upper flange to maximize the number and types of accessories that can be attached to the support bracket 10. For example, the accessory attachment openings can be spaced apart by about a ½ inch (1.3 cm) to about 3 inches (7.6 cm) on center. In other embodiments, the support bracket 10 may have accessory attachment openings 30 at other longitudinal dimensions. The accessory attachment openings 30 are arranged in a pattern as the accessory attachment opening extend longitudinally along the upper flange 24. As shown in FIGS. 1 and 2, the slots 30a and holes 30b alternate (e.g., slot, hole, slot, hole, slot, etc.) at the accessory attachment openings 30 extend longitudinally along the upper flange 24. In one embodiment, as shown in FIGS. 12 and 13, the web 22 defines accessory attachment openings 30 adjacent to at least one non-structural component opening. In the illustrate embodiment, the non-structural component openings 30 defined by the web 22 are two vertically oriented slots 30a disposed between two non-structural component openings, one slot adjacent the upper flange 24 and one slot adjacent the lower flange 26. Other configurations are within the scope of the present disclosure.

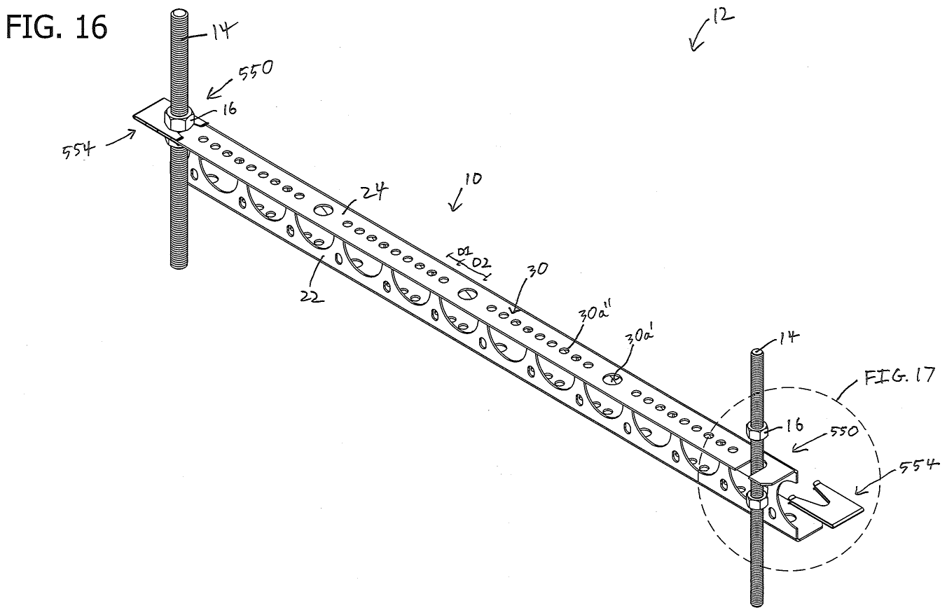

Other patterns of the accessory attachment openings 30 are within the scope of the present disclosure. For example, as shown in FIG. 16, the accessory attachment openings 30 are two different sizes (e.g., area) of circular openings, a large circular opening 30a′ and a small circular opening 30a″ arranged in a different pattern. The pattern consists of a single large opening 30a′ followed by a plurality of small openings 30a″ and then a single large opening to start the pattern over again (e.g., large, small, small, small, large, small, small, small, large, etc.). In other words, there is a plurality of small openings 30a″ with an area less than the area of the large openings 30a′ between adjacent large openings. There can be any number of small openings 30a″ between large openings 30a′, such as nine small openings 30a″ between large openings 30a′ as shown in FIG. 16. The numerous number of small openings 30a″ allows multiple accessories with generally any configuration to be attached to the support bracket 10 and be aligned with some element of the support bracket (e.g., non-structural component opening 28). In the illustrated embodiment, the small openings 30a″ are spaced apart (on center) from one another by a first distance D1 that is smaller than a second distance D2 between the small openings and the large openings 30a′. In one embodiment, the first distance D1 is 12 inch (13 mm) and the second distance D2 is 1 inch (2.5 cm). Other spacing distances, including even spacing between large and small openings 30a′, 30a″, are within the scope of the present disclosure. In one embodiment, the large opening 30a′ has a diameter of 12 inch (13 mm) and the small opening of ¼ inch (6 mm), although other sizes are within the scope of the present disclosure. In one embodiment, one or both of the large and small openings 30a′, 30a″ are slots.

In the preferred embodiment, the accessory attachment openings 30 are positioned and spaced apart such that each non-structural component opening 28 has a corresponding accessory attachment opening on the upper flange 24 that is aligned with the center of the non-structural component opening. Such an alignment allows accessories, such as non-structural component clamps C, to be aligned with the non-structural component opening 28 when they are connected to the support bracket 10, as shown in FIGS. 9 and 10. When non-structural component clamps C are used with the support bracket 10, preferably, the clamp holds the non-structural component in a position where the non-structural component is spaced apart from the edge of the web 22 defining the non-structural component opening 28 (e.g., the web 22 does not engage and support the non-structural component extending through the non-structural component opening when clamps are used). Preferably, there is also an accessory attachment opening 30 aligned with the midpoint between adjacent non-structural component openings 28 and, thus, the portion of the web 22 between adjacent non-structural component openings. This alignment allows accessories, such as described herein, to be positioned between adjacent non-structural component openings 28 and aligned with the portion of the web 22 therebetween. In one embodiment, the web 22 also defines accessory attachment openings 30 positioned around the non-structural component openings 28 (FIG. 10). For example, the web 22 can include two upper and lower slots 30a that are vertically oriented and vertically spaced apart between adjacent non-structural component openings 28.

Referring to FIGS. 1 and 2, the upper flange 24 includes at least one rod coupler, generally indicated at 50, configured to receive a support rod 14 to connect the support rod to the support bracket 10. In the illustrated embodiment, the upper flange 24 includes rod couplers 50 adjacent each end of the support bracket 10 (e.g., rod couplers at the left and right ends of the support bracket). Preferably, the upper flange 24 includes a rod coupler 50 aligned with the portion of the web 22 at either end of the support bracket 10 between the partial non-structural component opening 28 and the adjacent non-structural component opening so that the support rod 14 does not obstruct either of the non-structural component openings when connected to the support bracket 10. In other embodiments, the upper flange 24 may include one or more rod couplers 50 at other positions (e.g., longitudinal positions) on the upper flange. The rod coupler 50 can be any of the various rod couplers described herein. In the embodiment shown in FIGS. 1, 2 and 11A-11D, the rod coupler 50 includes a rod opening 52 defined by the upper flange 24 and a bendable tab 54 configured to move between open and closed positions to open and close a side of the rod opening 52. The rod opening 52 is configured to receive the support rod 14. The bendable tab 54 is attached to the upper flange 24 adjacent the free end. In one embodiment, the point of connection between the bendable tab 54 and the upper flange 24 may include a living hinge such that the bendable tab can be manually bent or moved relative to the upper flange. For example, the living hinge may be a portion between the upper flange 24 and bendable tab 54 having a reduced thickness (e.g., a thickness less than the thickness of the upper flange and bendable tab). In the illustrated embodiment, the upper flange 24 defines left and right rod openings 52 adjacent the respective left and right edge margins of the web 22.

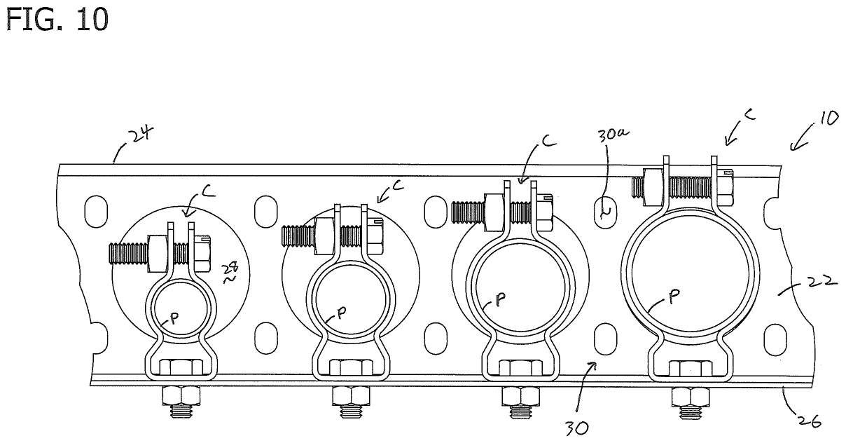

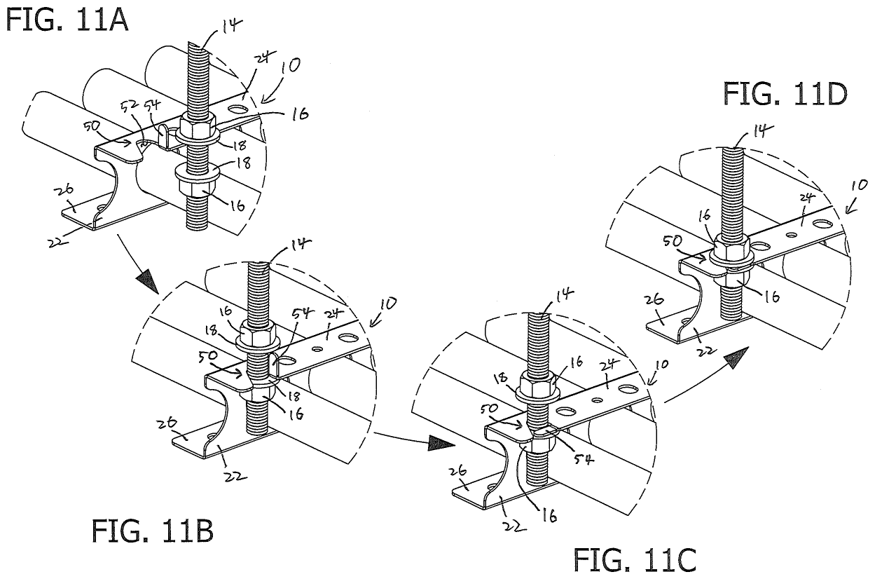

In FIG. 11A the bendable tab 54 is in the open position where the bendable tab is out of the plane defined by the upper flange 24 (e.g., the tab is moved upward) so that an open side of the rod opening 52 at the free end of the upper flange is open. In this position, the support rod 14 can be inserted into the rod opening 52 through the side (FIG. 11B). In FIG. 11C the bendable tab 54 is in the closed position where the bendable tab is received in the open side of the rod opening (e.g., the tab is moved downward) in order to close the open side of rod opening to secure the support rod 14 in the rod opening. In the closed position, the bendable tab 54 closes the side of the rod opening 52 such that the support rod 14 cannot pass there-through. By moving the bendable tab 54 between the open and closed positions, the support bracket 10 is able to be quickly connected to a support rod 14. The rod coupler 50 also allows a user to threadably mount nuts 16 and washers 18 to the support rod 14 before attaching the support bracket 10. In the illustrated embodiment, each support rod 14 includes a pair of nuts 16 and washers 18 positioned above and below the upper flange 24. Once the support rod 14 is positioned in the rod coupler 50, the upper and lower nuts 16 are each threadably moved so that the upper and lower washers 18 engage the top face and bottom face, respectively, of the upper flange 24 to secure the support bracket 10 to the support rod (FIG. 11D). The upper and lower washers 18 also engage the bendable tab 54 to secure the bendable tab in the closed position. In another embodiment, the rod coupler 50 comprises one of the accessory attachment openings 30, such as a slot 30a or hole 30b, that can receive the support rod 14 (e.g., at least one of the accessory attachment openings is sized and shaped to receive the support rod). In this embodiment, the one or more support rods 14 may be received in any of the accessory attachment openings 30. Preferably, the accessory attachment openings 30 in the upper flange 24 are disposed between the rod coupler 50, more specifically the rod opening 52, at either end of the support bracket.

The lower flange 26 extends from the lower edge margin of the web 22 to a free end. The lower flange 26 is generally rectangular and has opposite left and right edge margins, a top face and a bottom face. The lower flange 26 has a length extending between the right and left edge margins that is equal to the length L1 of the body 20. The lower flange 26 extends generally horizontally and is generally perpendicular to the web 22. In the illustrated embodiment, the lower flange 26 extends in the forward direction. Thus, in the illustrated embodiment, the support bracket 10 has a Z-cross sectional shape. In another embodiment, the lower flange 24 may extend in the rearward direction. Thus, in one embodiment, the upper flange 24 and lower flange 26 can extend in the same direction, either forward or rearward, such that the support bracket has a C-cross sectional shape. The lower flange 26 has a width W2 extending between the lower edge margin of the web and free end of the lower flange (FIG. 3). In one embodiment, the width W1 of the lower flange 26 is about 1 inch (2.5 cm), however, the lower flange can have a width that is greater or less than 1 inch. For example, in one embodiment the lower flange has a width W2 equal to the width W1 of the upper flange 24. The lower flange 26 and upper flange 24 are generally parallel to one another and lie in separate spaced apart planes.

The lower flange 26 can define one or more accessory attachment openings 30, as described above and in any configuration described above. Preferably, both the upper and lower flange 24, 26 have accessory attachment openings 30 to permit accessories to be attached in numerous configurations to the support bracket, such as above or below the support bracket or in front of or behind the web 22. In one embodiment, the accessory attachment openings 30 on the lower flange 26 have a different configuration than the accessory attachment openings on the upper flange 24. For example, in the illustrated embodiment (FIGS. 1 and 2), the accessory attachment openings 30 on the lower flange 26 have the same type of openings with the same, but offset, alternating arrangement than the accessory attachment openings of the upper flange 24. As a result of this offset arrangement, the holes 30b in the upper flange 24 are vertically aligned with the slots 30b in the lower flange 26 and the slots in the upper flange are vertically aligned with the holes in the lower flange. In addition, the slots 30a and/or holes 30b can have different sizes and/or dimensions as well. Moreover, the lower flange 26 can also include rod couplers 50, as described above. In other embodiments, such as shown in FIG. 16, the configuration of the accessory attachment openings 30 on the upper and lower flanges 24, 26 are identical.

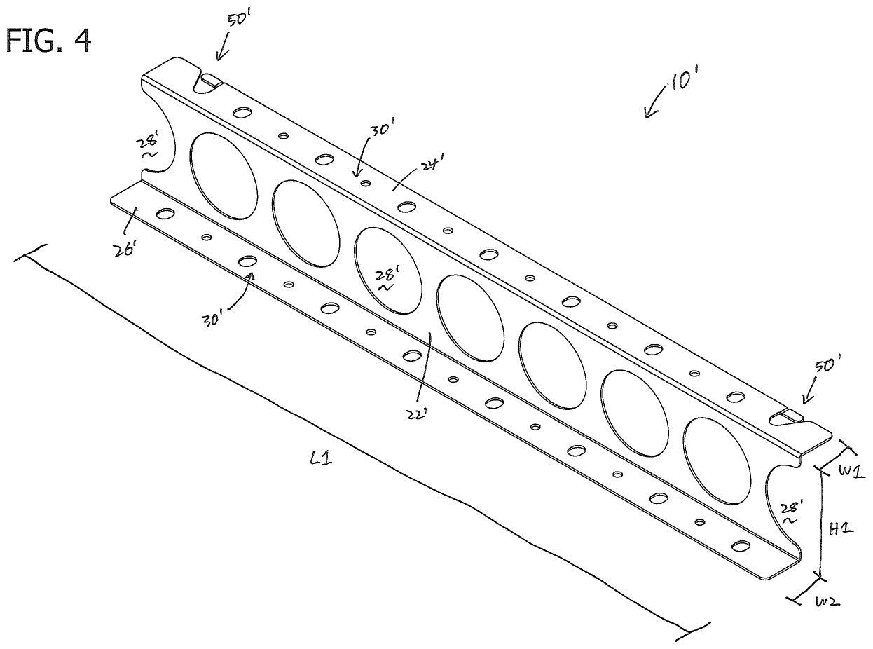

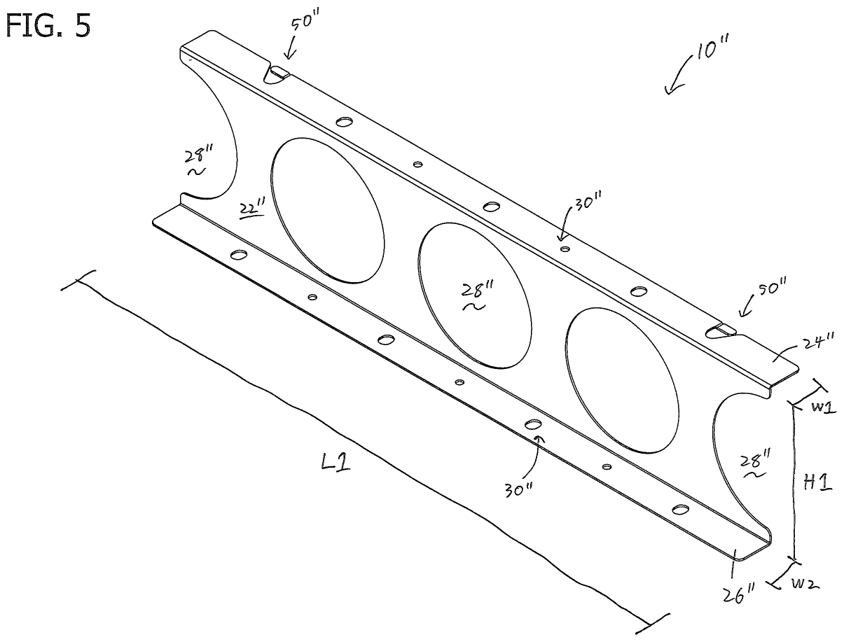

The support bracket 10 can have other dimensions than described above. For example, as shown in FIG. 4, a support bracket having a length L1 of 24 inches (61 cm), a width W1 and W2 of 1.3 inches (3.3 cm), and a height H1 of 3.25 inches (8.3 cm) is generally indicated at 10′. In this embodiment, the non-structural component openings 28′ have a diameter of about 2.4 inches (6.1 cm) so that the support bracket 10′ can support non-structural components, such as pipes P, having an outer diameter of about 2.25 inches (5.7 cm) or less. In another example, shown in FIG. 5, a support bracket having a length L1 of 24 inches (61 cm), a width W1 and W2 of 1.3 inches (3.3 cm), and a height H1 of 5.5 inches (14 cm) is generally indicated at 10″. In this embodiment, the non-structural component openings 28″ have a diameter of about 4.5 inches (11.4 cm) so that the support bracket 10″ can support non-structural components, such as pipes P, having an outer diameter of about 4 inches (10.2 cm) or less. Other than the dimensions described above, support brackets 10′ and 10″ are the same as support bracket 10 such that corresponding parts have the same reference number with a trailing prime (′) or double-prime (″), respectively.

The support bracket 10 may be formed from a generally rigid metal, such as low carbon steel, stainless steel, aluminum, or other metals, or from other material, such as fiberglass or plastic. In one embodiment, the support bracket 10 is formed from a single piece of material, such as a metal blank that is stamped from a piece of sheet metal and bent into shape. The support bracket 10 may be formed in other ways such as being extruded from an extrusion die, such as when forming the support bracket from aluminum. The support bracket 10 may have a thickness from about 0.5 mm to about 4 mm. In one non-limiting example, the support bracket 10 may be formed from 16 gauge (1.52 mm) sheet metal, 18 gauge (1.2 mm) steel sheet metal, or from 20 gauge (0.9 mm) steel sheet metal, although other gauges are within the scope of the present disclosure.

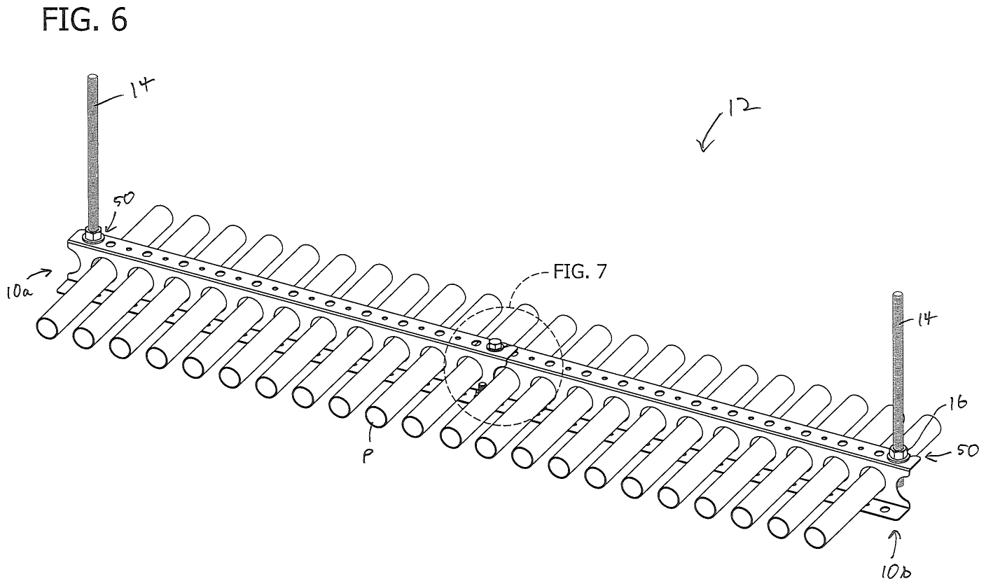

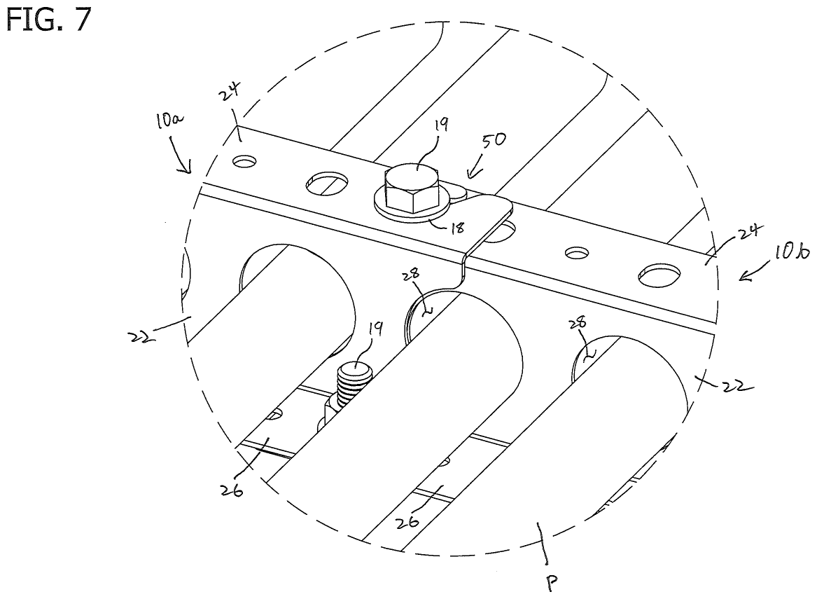

Referring to FIG. 6, in one embodiment of a hanger assembly 12, two or more support brackets 10 are arranged in a side-by-side, overlapping arrangement to increase the number of non-structural components that can be supported by the hanger assembly. In the illustrated embodiment, two support brackets 10a and 10b are coupled together, the right end of the first support bracket 10a in an overlapping relationship with the left end of the second support bracket 10b. The upper flanges 26 of the support brackets 10a, 10b are configured to be connected to one another. The rod couplers 50 on the upper flanges 24 at the right end of the first support bracket 10a and left end of the second support bracket 10b are aligned such that a single fastener 19 (e.g., fastener assembly including a bolt, nut, and/or washer) can be inserted there-through to connect the brackets together. In another embodiment, another support rod (not shown) is inserted through the aligned rod couplers 50 of the first and second support brackets 10a, 10b. In addition, the lower flanges 26 of the support brackets 10a, 10b are configured to be connected to one another. The lower flanges 26 of the adjacent support brackets 10a, 10b can include rod couplers 50 and/or accessory attachment openings 30 that are configured to align with one another such that another fastener 19 or support rod 14 can be inserted there-though to connect the brackets together. When the two support brackets 10a, 10b are connect together, the respective webs 22, upper flanges 24 and lower flanges 26 of each support bracket engage each other.

As mentioned above, the left and right edge margins of the support bracket 10 at least partially define non-structural component openings 28 (e.g., non-structural component openings having an open shape). As shown in FIG. 6, these at least partially defined non-structural component openings 28 at the left and right edge margins are configured to align with non-structural component openings (e.g., non-structural component openings having a closed shape) of adjacent support bracket 10, such that the connection of two support brackets 10a, 10b together does not obstruct the non-structural component openings of either support bracket. In the illustrated embodiment, the partially defined non-structural component opening 28 at the right edge margin of the first support bracket 10a is configured to align with the left most fully defined non-structural component opening of the second support bracket 10b. Similarly, the partially defined non-structural component opening 28 at the left edge margin of the second support bracket 10b is configured to align with the right most fully defined non-structural component opening of the first support bracket 10a. It is understood that the adjacent support brackets 10a, 10b can be overlapped in a side-by-side arrangement in other manners. For example, in one embodiment, adjacent support brackets 10a, 10b overlap one another such that one or more non-structural component openings 28 (e.g., fully defined non-structural component openings) are aligned. In this embodiment, rod couplers 50 and/or accessory attachment openings 30 on one support bracket 10 can be aligned with the rod couplers and/or accessory attachment openings on the other support bracket so that a fastener 19 can be inserted through the one or more aligned openings to secure the two support brackets together. In other embodiments of the hanger assembly 12, two or more support brackets 10 are stacked on top of each other (e.g., the upper flange 24 of one support bracket is attached to the lower flange 26 of another support bracket) to increase the number of non-structural components that can be supported by the hanger assembly. In this embodiment, the one or more support brackets can be arranged such that the support rod 14 only connects to one support bracket or connects to several support brackets.

Additional configurations of the rod coupler will now be described. The following rod couplers can be used with any of the support brackets 10 described herein to attach a support rod 14 to the support bracket.

Referring to FIG. 13, another embodiment of a rod coupler for the support bracket 10 is generally shown at 150. In this embodiment, the rod coupler comprises a knock-out 154 that defines a rod opening 152 configured to receive the support rod 14. The knock-out 154 can be manually removed from the support bracket 10. In this case, when the knock-out 154 is attached to support bracket 10, the knock-out defines a first size of the rod opening 152. By removing the knock-out 154, a second, larger size of the rod opening 152 is created that is defined by the upper flange 24. For example, when the knock-out defines the rod opening 152, the rod opening can be sized to receive a ⅜ inch (1 cm) diameter support rod 14 (e.g., the first size) and when the knock-out is removed, the rod opening can be sized to receive a ½ inch (1.3 cm) diameter support rod (e.g., the second size). Other sizes are within the scope of the present disclosure. Accordingly, the rod coupler 150, specifically the rod opening 152, can be adjusted in size to be in a close fitting relationship with the support rod 14 so that washers are not needed to secure the support bracket 10 to the support rod (e.g., nuts 16 alone are sufficient). In the illustrated embodiment, the knock-out 154 is a concentric knock-out. In other embodiments, the knock-out may be a non-concentric knock-out. An example of such a rod coupler with a non-concentric knock-out is generally indicated at 250 in FIG. 12. Other than having a non-concentric the knock-out 254, the rod coupler 250 is generally the same as rod coupler 150 and also defines a rod opening 252 that can vary in size by removing the knock-out. The non-concentric knock-out 254 does provide a few advantages over the concentric knock-out 154. First, the non-concentric knock-out positions the smaller size rod opening 252 closer to the web 22, which reduces the moment, and therefore bending, experienced by the upper flange 24 when the support bracket 10 supports non-structural components. Second, the non-concentric knock-out is generally easier to manually remove.

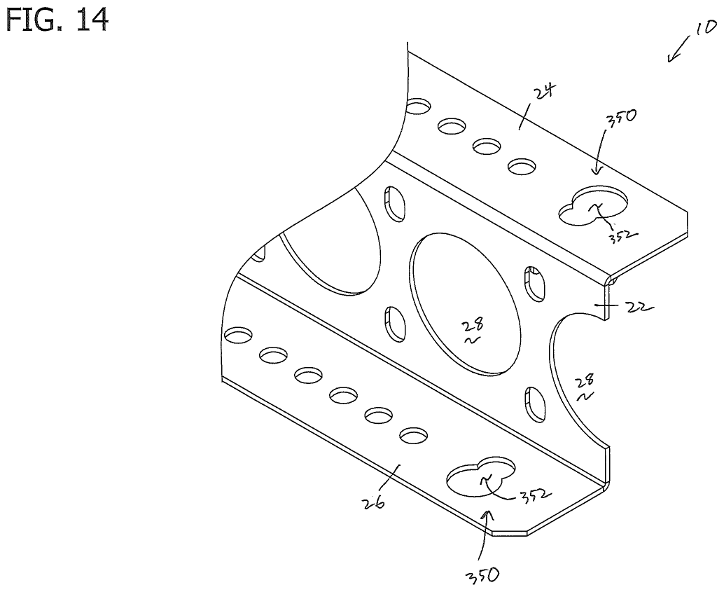

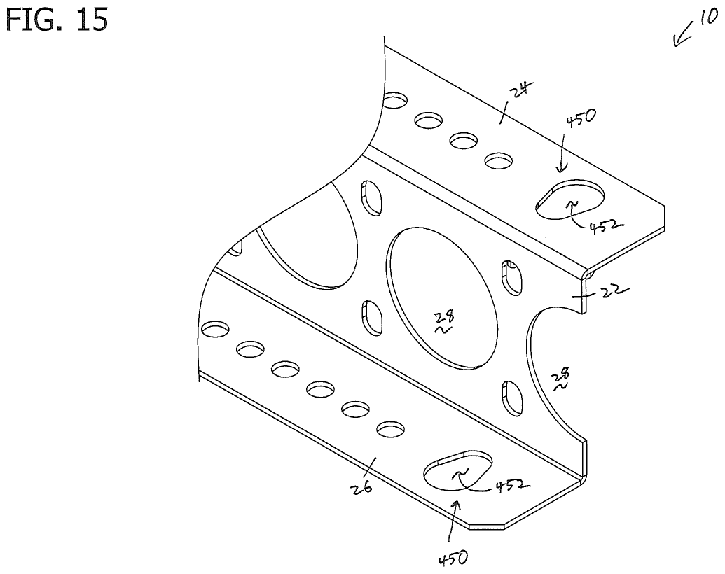

Referring to FIG. 14, another embodiment of a rod coupler for the support bracket 10 is generally shown at 350. In this embodiment, the rod coupler 350 comprises a rod opening 352 configured to receive the support rod 14. The rod opening 352 hay a keyhole shape with a larger diameter open portion continuous with a smaller diameter open portion. This allows support rods 14 of different sizes (e.g., diameters) to be inserted into the rod opening 352 and positioned in the portion of the opening that is closest to the support rod's size. For example, the large diameter portion can be sized to receive a ½ inch (1.3 cm) diameter support rod 14 and the smaller diameter portion can be sized to receive a ⅜ inch (1 cm) diameter support rod. Because the support rods 14 of various sizes are able to be in a close fitting relationship with some portion of the rod opening 352, washers are not needed to secure the support rods to the support bracket 10. Instead, the engagement of the nuts 16, such as the illustrated slip-on lock nut sold by Eaton as the Buzznut™, directly with the top and bottom faces of the upper flange 24 secures the support rods to the support bracket 10.

Referring to FIG. 15, another embodiment of a rod coupler for the support bracket 10 is generally shown at 450. Rod coupler 450 is generally the same as rod coupler 350 except that the rod opening 452 of the rod coupler 450 has a slot shape with one end of the rod opening having a larger width (e.g., diameter) than the opposite end. Accordingly, the rod coupler 450 can receive support rods 14 of various sizes and the support rods can be positioned within the rod opening 452 such that the support rod is in a close fitting relationship with at least a portion thereof (e.g., the support rod engages the edges defining the rod opening). This eliminates the need to use washers to facilitate the connection between the support bracket 10 and the support rods, as described above.

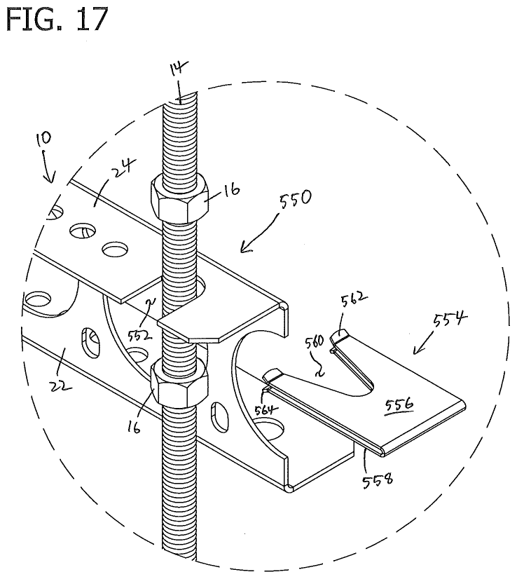

Referring to FIGS. 16 and 17, another embodiment of a rod coupler for the support bracket 10 is generally shown at 550. In this embodiment, the rod coupler 550 includes a rod opening 552 defined by the upper flange 24 and a clip 554. The rod opening 552 is a slot extending in the forward direction from the free end of the upper flange 24. The support rod 14 can be inserted into the rod opening 552 through the open side of the rod opening at the free end of the upper flange 24. The clip 554 is configured to close the open side of the rod opening 552 once the support rod is received therein to secure the support rod in the rod opening. The clip 552 includes a top jaw 556 and a bottom jaw 558 coupled together and configured to receive a portion of the upper flange 24 there-between. In the illustrated embodiment, the top and bottom jaw 556, 558 are connected together at a first side edge margin and are resiliently deflectable with respect to one another. The top and bottom jaw 556, 558 each define a V-shaped slot 560 extending from a second side edge margin opposite the first side edge margin. The V-shape of the slots 560 allows the clip 554 to be in a close fitting relationship with support rods 14 of various sizes. The slots 560 on the top and bottom jaws 556, 558 are aligned and receive the support rod when the clip 554 is attached to the support bracket 10.

As shown in FIG. 16, when the clip 554 is attached to the support bracket 10, a portion of the top and bottom jaws 556, 558 extends past the rod opening 552 to close the open side of the rod opening. The clip 554 slides onto the upper flange 24 over the side edge margin until the support rod 14 engages the edges of the top and bottom jaws 556, 558 defining the slots 560 to form the close fitting relationship. When the clip 554 is attached to the support bracket 10, the engagement of the upper flange 24 with the top and bottom jaws 556, 558 deflects the top and bottom jaws away from each other, which results in the top and bottom jaws applying a clamping force to the upper flange to help secure the clip thereon. The clip 554 is further secured to the support bracket 10 through the force applied by upper and lower nuts 16 engaging the top and bottom jaws 556, 558. The top and bottom jaws 556, 558 may also include upper and lower inclined tabs 562 and 564, respectively, extending from the second edge margin of each jaw to facilitate the placement of the clip 554 on the upper flange 24.

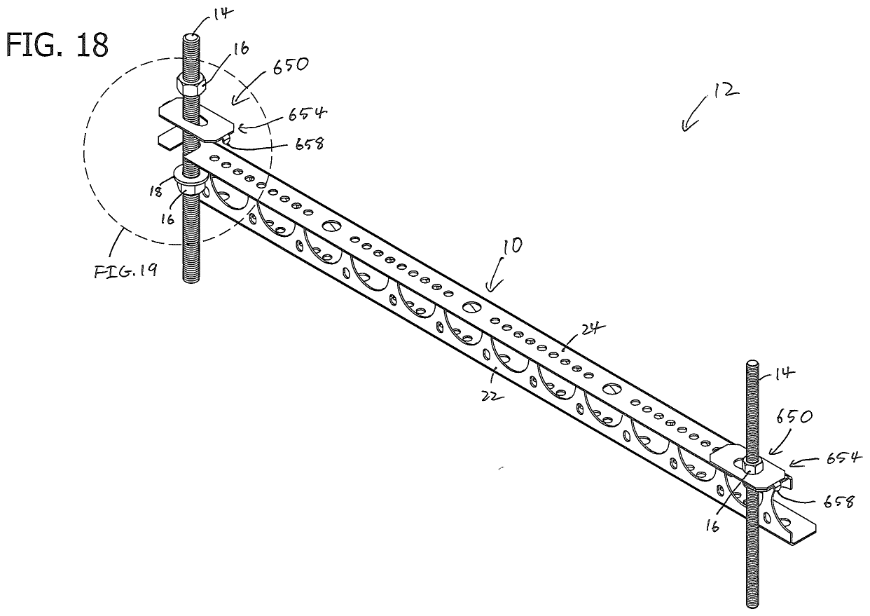

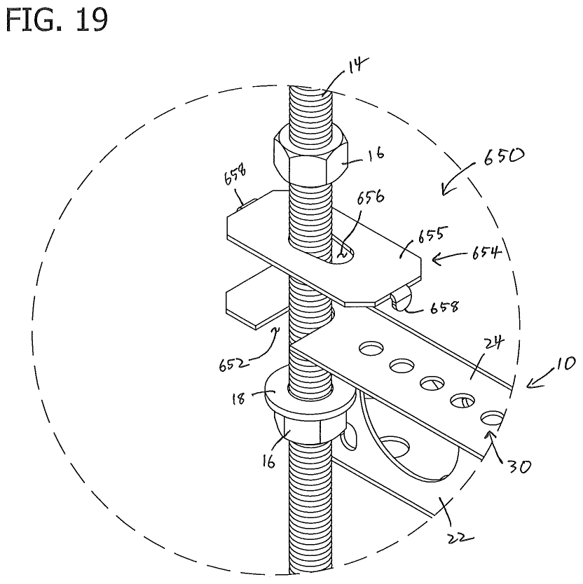

Referring to FIGS. 18 and 19, another embodiment of a rod coupler for the support bracket 10 is generally shown at 650. In this embodiment, the rod coupler 650 includes a rod opening 652 that is the same as rod opening 552 and a rod securement plate 654. The rod securement plate 654 is configured to close the open side of the rod opening 652 once the support rod 14 is received therein to secure the support rod in the rod opening. The rod securement plate 654 has a generally planar body 655 with a rectangular shape. The body 655 defines a rod plate opening 656 that is the same a rod opening 452. The rod plate opening 656 is oriented to be generally parallel with the length L1 of the support bracket 10 when the rod securement plate 654 is connected to the upper flange 24 and is configured to overlie the top or lower flange 24, 26. Two insertion tabs 658 extend generally vertically downward from opposite side edge margins of the body 655. The insertion tabs 658 are configured to engage the upper flange 24 of the support bracket 10 to help keep the rod securement plate 654 on the upper flange 24. To attach the support rod 14 to the support bracket 10, the support rod is inserted into the rod plate opening 656 and positioned at the end of the rod plate opening that best forms a close fitting relationship (e.g., a larger size support rod is positioned at the wider end of the rod plate opening and a smaller size support rod is positioned as the narrower end of the rod plate opening). The rod securement plate 654 is then moved into engagement with the top face of the upper flange.

As shown in FIG. 18, when the rod securement plate 654 is positioned on the upper flange 24 and the support rod 14 is positioned in the widest part of the rod plate opening 656, one insertion tab 658 engages the side edge margin of the upper flange and the other insertion tab is received in one of the accessory attachment openings 30. Similarly, the rod securement plate 654 can be flipped or turned 180° about a vertical axis for smaller support rods 14 such that when the smaller support rod is positioned in the narrower part of the rod plate opening 656, one insertion tab 658 still engages the side edge marring of the upper flange 24 and the other insertion tab is received in one of the accessory attachment openings 30. The engagement of the insertion tabs 658 with the upper flange 24 helps position the rod securement plate on the upper flange 24 and prevents the rod securement plate from being removed from the upper flange. As shown in FIG. 18, when the rod securement plate 654 is attached to the support bracket 10, the rod securement plate extends past the rod opening 652 to close the open side of the rod opening, securing the support rod 14 in the rod opening. As described above, the rod securement plate 654 is further secured to the support bracket 10 through the force applied by an upper nut 16 engaging the rod securement plate.

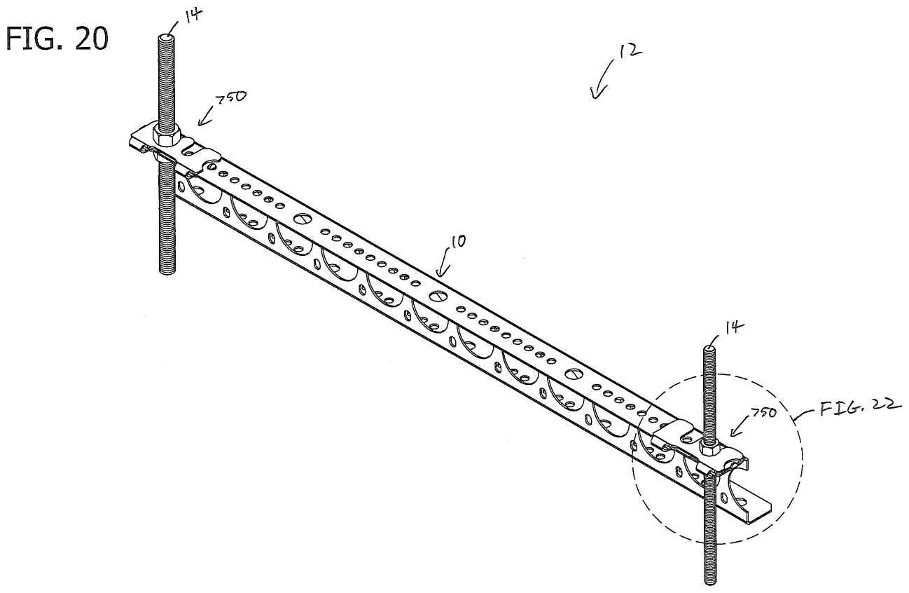

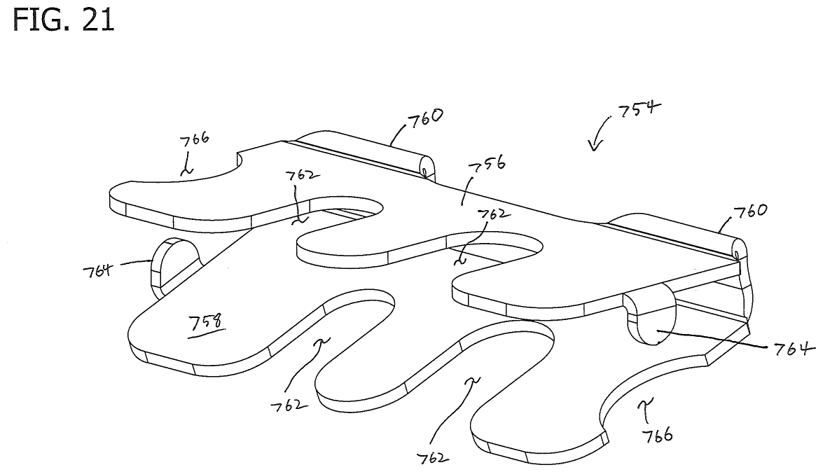

Referring to FIGS. 20-22, another embodiment of a rod coupler for the support bracket 10 is generally shown at 750. In this embodiment, the rod coupler 750 includes a rod opening (not shown) that is the same as rod opening 552 and a clip 754. The clip 754 is configured to close the open side of the rod opening once the support rod is received therein to secure the support rod in the rod opening. The clip includes a top jaw 756 and a bottom jaw 758 coupled together with one or more resiliently deflectable connection portions 760 extending between adjacent rear edge margins of the top and bottom jaws. The top and bottom jaws 756, 758 are configured to receive a portion of the upper flange 24 there-between. The top and bottom jaw 756, 758 each define at least one slot 762 extending from a front edge margin. The slots 762 are configured to receive the support rod 14. In one embodiment, the slots 762 are the same size and shape as the rod opening. The slots 762 on the top and bottom jaws 756, 758 are aligned and are configured to receive the support rod when the clip 754 is attached to the support bracket 10. The clip 754 is configured to slide over the free end of the upper flange 24 such that the base of the slot 762 engages and pushes the support rod 14 against the base of the rod opening to create a close fitting relationship between the clip and the support rod. The clip 754 also includes insertion tabs 764 configure to engage the upper flange 24 of the support bracket 10 to keep the clip on the upper flange 24. In the illustrated embodiment, one insertion tab 764 extends from a left edge margin of the top jaw 756 vertically downward. Correspondingly, a left edge margin of the bottom jaw 758 defines an insertion tab receiving space 766 configured to receive the insertion tab 764 extending from the top jaw 756, as explained in more detail below. Similarly, another insertion tab 764 extends from the right edge margin of the bottom jaw 758 vertically upward and, correspondingly, a right edge margin of the top jaw 756 defines an insertion tab receiving space 766 configured to receive the insertion tab extending from the bottom jaw.

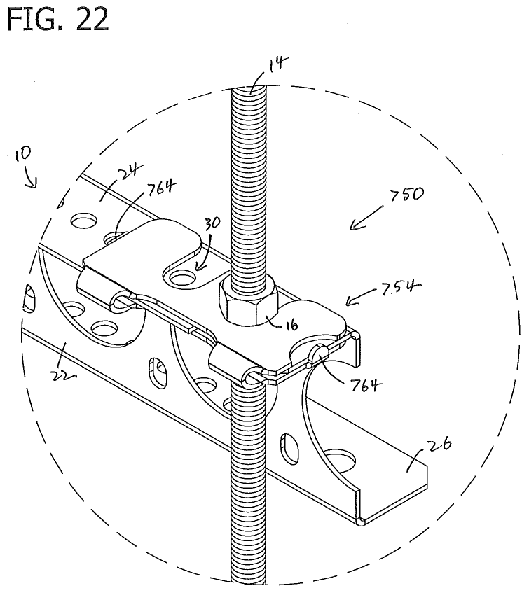

As shown in FIG. 22, when the clip 754 is attached to the support bracket 10, the clip 754 closes the open side of the rod opening at the free end of the upper flange to secure the support rod 14 in the rod opening. The clip 754 slides onto the upper flange 24 over the free end until the support rod 14 engages the edges of the top and bottom jaws 556, 558 defining the slots 762 to form the close fitting relationship between the clip and the support rod. When the clip 754 is attached to the support bracket 10, the engagement of the upper flange 24 with the top and bottom jaws 756, 758 deflects the one or more connection portions 760 such that the top and bottom jaws move away from each other. As a result, the top and bottom jaws 756, 758 apply a clamping force to the upper flange 24 to help secure the clip 754 thereon. As shown in FIG. 22, when the clip 754 is positioned on the upper flange 24, one insertion tab 764 engages the side edge margin of the upper flange and the other insertion tab is inserted through one of the accessory attachment openings 30. Each insertion tab 764 extends into its corresponding insertion tab receiving space 766 to allow the top and bottom jaws 756, 758 to close and engage the upper flange 24. The engagement of the insertion tabs 764 with the upper flange 24 helps prevent the clip 754 from being removed from the upper flange. As described above, the clip 754 is further secured to the support bracket 10 through the force applied by upper and lower nuts 16 engaging the clip. In the preferred embodiment, any additional slots 762 that do not engage the support rod 14 are configured to align with one or more of the accessory attachment openings 30 so that the clip 754 does not obstruct these openings, allowing them to be used to attach accessories to the support bracket 10.

The clips 554 and 764 and rod securement plate 754 may be formed from rigid metal, such as low carbon steel, stainless steel, aluminum, or other metals, or from other material, such as fiberglass or plastic. In one embodiment, the clips 554 and 764 and rod securement plate 754 are formed from a single piece of material, such as a metal blank that is stamped from a piece of sheet metal and bent into shape. In one non-limiting example, the clips 554 and 764 and rod securement plate 754 may be formed from 16 gauge (1.52 mm) sheet metal, 18 gauge (1.2 mm) steel sheet metal, or from 20 gauge (0.9 mm) steel sheet metal, although other gauges are within the scope of the present disclosure.

The hanger assembly 12 can include a variety of different coupling devices, described below, to attach adjacent support brackets 10 together in a side-by-side, non-overlapping arrangement. These coupling devices can be used with any of the support brackets describe herein. The coupling devices may also be connected to the support rod 14 and/or be used to connect the support brackets 10 to the support rod.

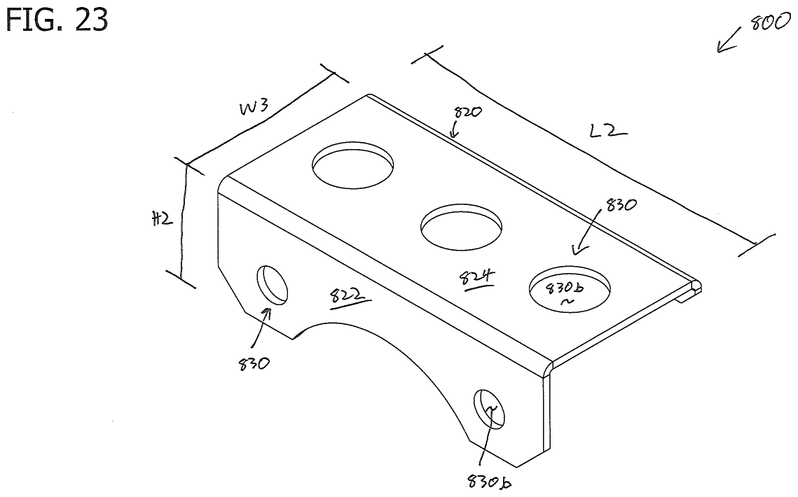

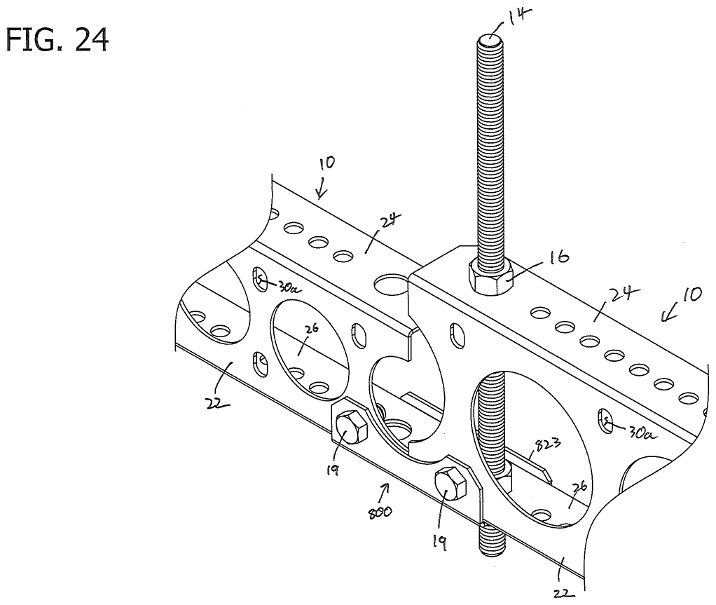

Referring to FIGS. 23 and 24, one embodiment of a coupling device for connecting adjacent support brackets 10 together is generally shown at 800. The coupling device 800 includes a body 820 having a upper flange 824 and a side flange 822. The top and side flanges 824, 822 are generally planar. The body 820 has a length L2 extending between opposite ends of the body and a height H2 extending between the top and bottom of the body. The upper flange 824 is generally rectangular and has opposite front and rear edge margins, opposite left and right edge margins, a top face and a bottom face. The rear edge margin defines a free end of the upper flange 824. The upper flange 824 has a length extending between the right and left edge margins that is equal to the length L1 of the body 820. The upper flange 824 extends generally horizontally. The upper flange 824 has a width W3 extending between the front and rear edge margins. In the preferred embodiment, the width W3 of the upper flange 824 is the same as the width W1 or W2 of the top and lower flanges 24, 26 of the support bracket 10. The upper flange 824 can define one or more accessory attachment openings 830 that are the same as accessory attachment openings 30 described above. As explained in more detail below, the accessory attachment openings 830 are used to connect the coupling device 800 to the support brackets 10 and/or the support rod 14. The accessory attachment openings 830 on the upper flange 824 are configured to align with the accessory attachment openings 30 on either the top or lower flanges 24, 26 of the adjacent support brackets 10. In the illustrated embodiment, the accessory attachment openings 830 on the upper flange 824 are three holes 830b spaced apart along the length L2 of the body 820. In another embodiment, the accessory attachment openings 830 on the upper flange 824 are slots 830a. Further still, in another embodiment, the accessory attachment openings 830 on the upper flange 824 are a mix of slots 30a and holes 30b. For example, the upper flange 824 may include three accessory attachment openings 830, the middle opening being a hole 830b and the two outside openings being slots 830a.

The side flange 822 extends from the front edge margin of the upper flange 822 to a free end in a vertical direction that is generally downward. In the illustrated embodiment, the side flange 822 is generally perpendicular to the upper flange 824. The side flange 822 is generally planar and rectangular. The side flange 822 has opposite upper and lower edge margins, opposite right and left edge margins, a front face, and a rear face. The side flange has a length extending between the right and left edge margins that is equal to the length L2 of the body 820. The side flange 822 has a height extending between the upper and lower edge margins that is equal to the height H2 of the body 820. As shown in FIG. 23, the height H2 of the side flange 822 is less than the height H1 of the support bracket 10. The side flange 822 includes one or more accessory attachment openings 830, as described above. As explained in more detail below, accessory attachment openings 830 on the side flange 822 are used to connect the coupling device 800 to the support brackets 10. The accessory attachment openings 830 on the side flange 822 are configured to align with the accessory attachment openings 30 on the webs 22 of the adjacent support brackets 10. As described above, the accessory attachment openings can be slots 830a, holes 830b or any combination of the two. The lower edge margin of the side flange 822 can be sized and shaped to correspond to the size and shape of the non-structural component openings 28 (specifically, the partial non-structural component openings at the opposite ends of the support bracket 10) so that when the coupling device 800 is connected to the support brackets, the side flange does not obstruct the non-structural component openings of the support brackets.

The coupling device 800 is configured to overlie and engage adjacent support brackets 10. The upper flange 824 is configured to overlie and engage a portion of either the top or lower flange 24, 26 of each of the support brackets 10. Similarly, the side flange 822 is configured to overlie and engage a portion of the web 22 of each of the support brackets 10. As shown in FIG. 24, when the coupling device 800 is used to connect adjacent support brackets 10, the lower edge margin of the side flange 822 is sized and shaped such that the side flange does not obstruct one of the non-structural component openings 28 of either support bracket. In one embodiment, only a single coupling device 800 is used to connect the support brackets. For example, as shown in FIG. 24, only one coupling device 800 is used to the central and lower flanges 22, 26 of the support brackets. The accessory attachment openings 830 on the side flange 822 are aligned with accessory attachment openings 30 on each of the webs 22 of the support brackets such that a fastener 19 can be inserted therein to secure the coupling device 800 to the support brackets. Similarly, the accessory attachment openings 830 on the upper flange 824 are aligned with accessory attachment openings on each of the lower flanges 26 of the support brackets such that a fastener can be inserted therein to secure the coupling device 800 to the support brackets. Alternatively, a support rod 14 can be inserted into the aligned accessory attachment openings 830 in the upper flange 822 of the coupling device 800 and the lower flange 26 of one of the support bracket 10 to secure both the coupling device and the support rod to the support bracket. In another embodiment, the support rod 14 is only inserted into one of the accessory attachment openings 830 of the coupling device 800 to connect the support rod to the support brackets 10, via the coupling device. The adjacent support brackets 10 may engage each other when connected by the coupling device 800 or they may be spaced apart.

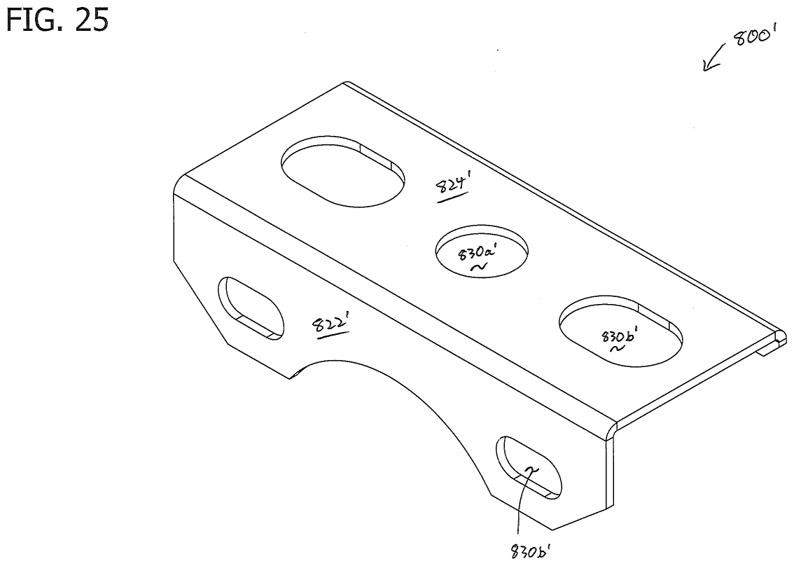

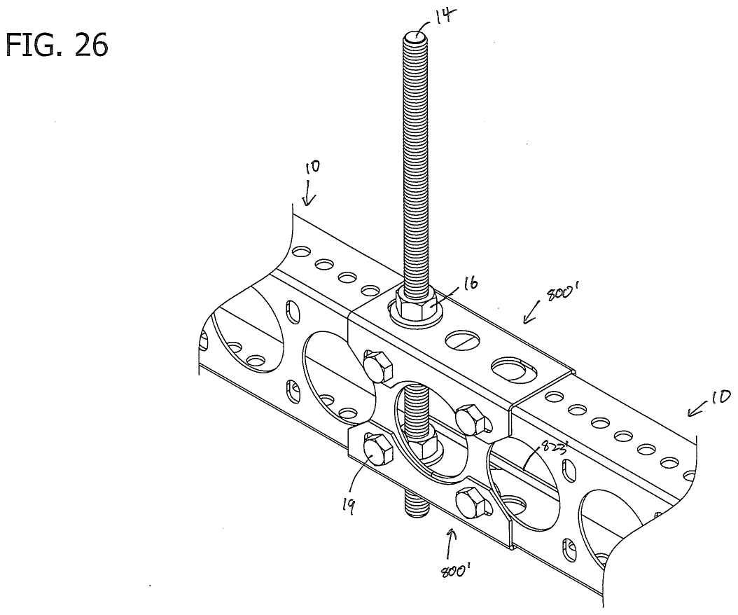

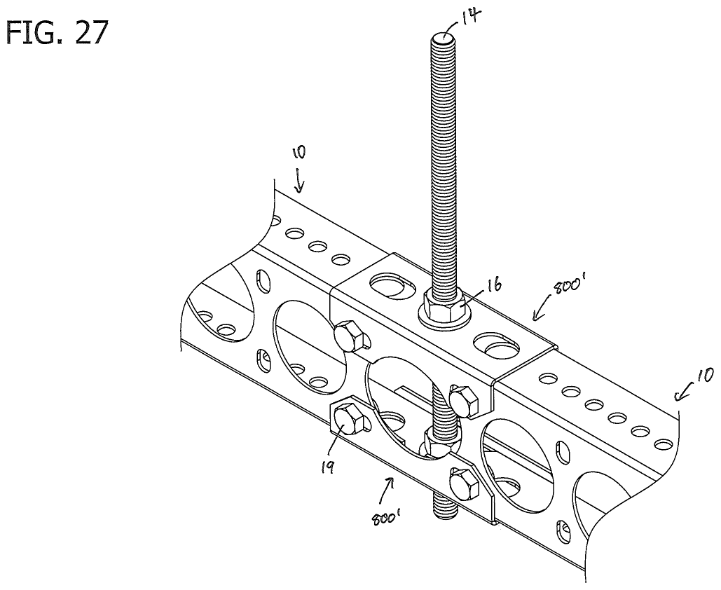

In one embodiment, the coupling device 800 can be used to connect adjacent support brackets 10 of different sizes, such as support brackets with different heights H1. Further still, in one embodiment, two coupling devices can be used to connect adjacent support brackets 10 of the same height H1. An example of this is shown in FIGS. 25-27 with coupling device 800′, which is generally the same as coupling device 800, such that corresponding parts have the same reference number but with a trailing prime. In this embodiment, one coupling device 800′ is connected to the central and lower flanges 22, 26 and the other coupling device is connected to the central and upper flanges 22, 24. In such an embodiment, individual fasteners 19 could be used, as described above, or a support rod 14 could extend through and be connected to both coupling devices 800 (FIG. 26). In another embodiment, the support rod 14 is only inserted into one of the accessory attachment openings 830a′ of the coupling device 800′ to connect the support rod to the support brackets 10 such that the support brackets are spaced apart (FIG. 27). In the illustrated embodiment, the coupling device 800′ is shown connecting support brackets with a C-shaped cross section. In another embodiment, the coupling device is connected to support brackets having a Z-shaped cross section.

In one embodiment, the coupling device 800 includes a second side flange 823 that extends from the rear edge margin of the upper flange 822 to a free end in a vertical direction that is generally downward. The second side flange 823 is generally planar, has a generally rectangular shape, is generally perpendicular to the upper flange 824 and is generally parallel to the side flange 822. The second side flange 823 has a height extending between upper and lower edge margins that is small so that the second side flange does not obstruct the non-structural component openings 28 of the support brackets. For example, the second side flange may have a height of 14 inch (6 mm). Together, the side flange 822, upper flange 824, and second side flange 823 define a channel configured to receive either the top or lower flange 24, 26 of the support bracket to increase the strength of the connection provided by the coupling device 800.

Referring to FIGS. 28-31, another embodiment of a coupling device for connecting adjacent support brackets 10 together is generally shown at 900. The coupling device 900 includes a body 920 having a web 922, a upper flange 924 and a lower flange 926. Thus, the coupling device 900 is similar to support bracket 10, described above, and where analogous parts are used, reference numerals “900” units higher are employed. The coupling device 900 is similar to support bracket 10 except that the coupling device is configured to extend around and engage the support bracket. The body 920 has a length L3 extending between opposite ends of the body and a height H3 extending between the top and lower flanges 924, 926 of the body. The length L3 of the body 920 is shorter than the length L1 of the support bracket 10 and the height H3 of the body is greater than the height H1 of the support bracket 10. In one embodiment, the length L3 of the body 920 is about 6 inches (15 cm), however, the coupling device 900 can have a length that is greater or less than 6 inches. The height H3 of the body 920 is such that the upper flange 924 and lower flange 926 overlap and engage the top and lower flanges 24, 26 of the support bracket 10. In addition, the coupling device 900 is configured to couple support brackets 10 having a C-shaped cross section. Accordingly, both the top and lower flanges 924, 926 extend in the same direction from the web 922. The top and lower flanges 924, 926 each have a width W4 extending from the web to a free end that is, preferably, the same as the widths W1, W2 of the top and lower flanges 24, 26, respectively.

The web 922, upper flange 924, and lower flange 926 can define one or more accessory attachment openings 930 that are the same as accessory attachment openings 30, described above. As explained in more detail below, the accessory attachment openings 930 are used to connect the coupling device 900 to the support brackets 10 and/or the support rod 14. The accessory attachment openings 930 on the upper flange 924 are configured to align with the accessory attachment openings 30 the upper flanges 24 of the adjacent support brackets, the accessory attachment openings 930 on the web 922 are configured to align with the accessory attachment openings 30 on the webs 22, and the accessory attachment openings 930 on the lower flange 926 are configured to align with the accessory attachment openings 30 on the lower flanges 26. As described above, the accessory attachment openings 930 can be slots 930a, holes 930b or any combination of the two.

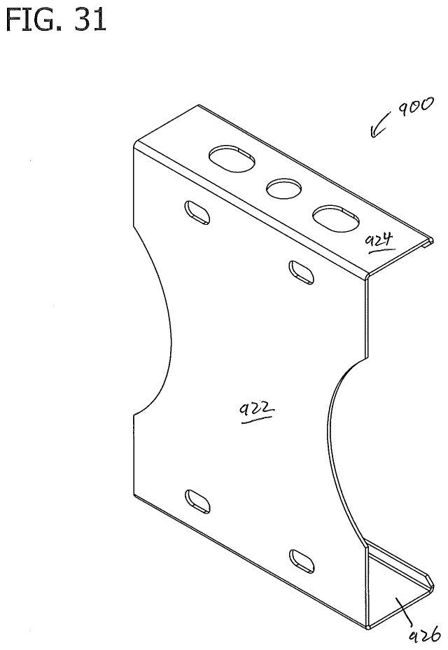

In addition, in one embodiment, the web 922 defines one or more non-structural components openings 928 that are the same as non-structural component openings 28. The non-structural component openings 928 are configured to align with one or more of the non-structural component openings 28 of the adjacent support brackets 10 so that the coupling device 900 does not obstruct the non-structural component openings 28. For example, one non-structural component opening 930 on the web 922 can align with the partial non-structural component openings 30 defined by the edge margins of the webs 22 of the adjacent support brackets 10. In one embodiment, the web 922 may not define a non-structural component opening 928 (FIG. 31). Moreover, in the preferred embodiment, the left and right edge margins of the web 922 are sized and shaped to correspond to the size and shape of the non-structural component openings 28 on the adjacent support brackets 10 so that the left and right edge margins of the web do not obstruct the non-structural component openings on the adjacent support brackets.

In one embodiment, a second side flange 923, that is the same as second side flange 823, extends from the rear edge margin (e.g., free end) of either the top or lower flanges 924, 926 to a free end in a vertical direction that is either downward or upward, respectively. In the illustrated embodiment, the second side flange 923 extends upward from the lower flange 926. In another embodiment, both the coupling device 900 includes second side flanges 923 extending from both top and lower flanges 924, 926. As described above, the web 922, second side flange 923 and either the top or lower flange 924, 926 define a channel configured to receive either the top or lower flange 24, 26 of the support bracket 10 to increase the strength of the connection provided by the coupling device 900.

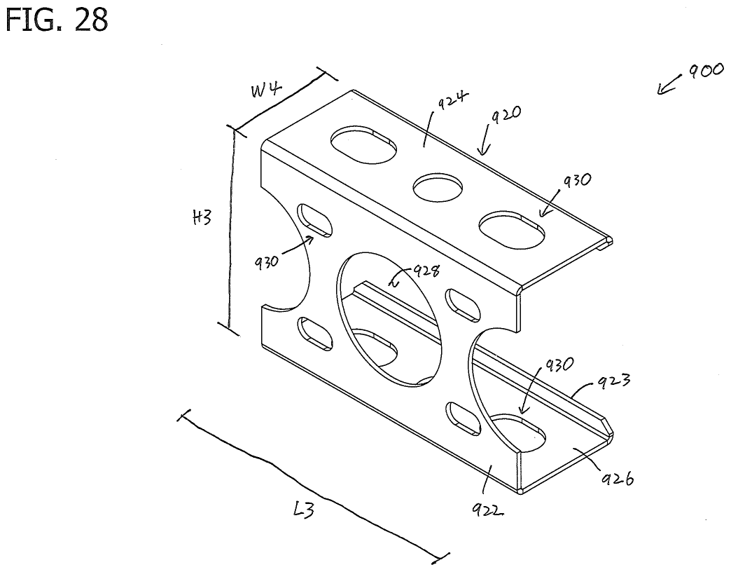

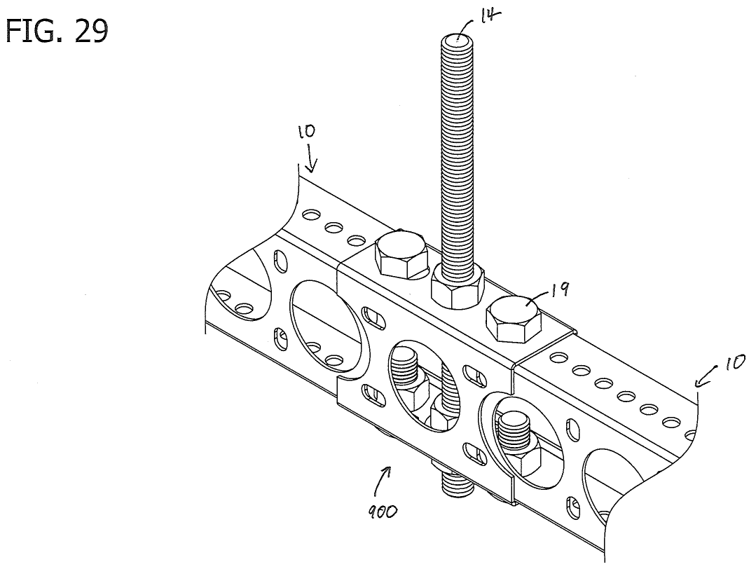

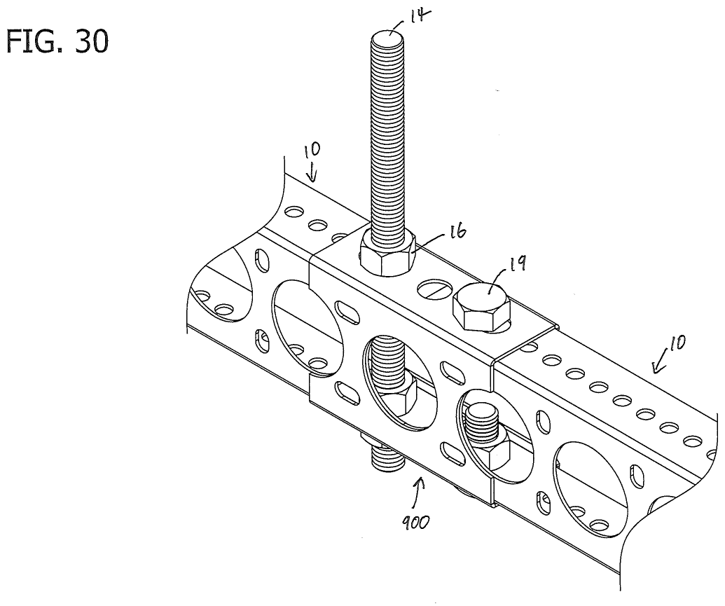

As shown in FIGS. 29 and 30, the coupling device 900 connects two adjacent support brackets 10 together in a side-by-side, non-overlapping arrangement. When attached to the support brackets 10, the web 922 overlies and engages the webs 22 of the support brackets, the upper flange 924 overlies and engages the upper flanges 24, and the lower flange 926 overlies and engages the lower flanges 26. When the coupling device 900 is mounted on the adjacent support bracket 10, the non-structural component opening 928 and/or left and right edge margins of the web 922 align with one or more of the non-structural component openings 30 of the adjacent support brackets 10 so that the coupling device does not obstruct the non-structural components of either support bracket. The accessory attachment openings 930 on the coupling device are aligned with accessory attachment openings 30 on each of the support brackets 10 such that a fastener 19 can be inserted therein to secure the coupling device to the support brackets. Alternatively, a support rod 14 can be inserted into the aligned accessory attachment openings 930, 30 in the upper flanges 922, 30 and/or lower flanges 926, 26 of the coupling device 900 and one of the support brackets 10, respectively, to secure both the coupling device and the support rod to the support bracket (FIG. 30). In another embodiment, the support rod 14 is only inserted into the accessory attachment openings 930 of the coupling device 900 to connect the support rod to the support brackets 10, via the coupling device (FIG. 29). The adjacent support brackets 10 may engage each other when connected by the coupling device 900 or they may be spaced apart.

The coupling devices 800, 900 may be formed from rigid metal, such as low carbon steel, stainless steel, aluminum, or other metals, or from other material, such as fiberglass or plastic. In one embodiment, the coupling devices 800, 900 are formed from a single piece of material, such as a metal blank that is stamped from a piece of sheet metal and bent into shape. In one non-limiting example, the coupling devices 800, 900 may be formed from 16 gauge (1.52 mm) sheet metal, 18 gauge (1.2 mm) steel sheet metal, or from 20 gauge (0.9 mm) steel sheet metal, although other gauges are within the scope of the present disclosure.

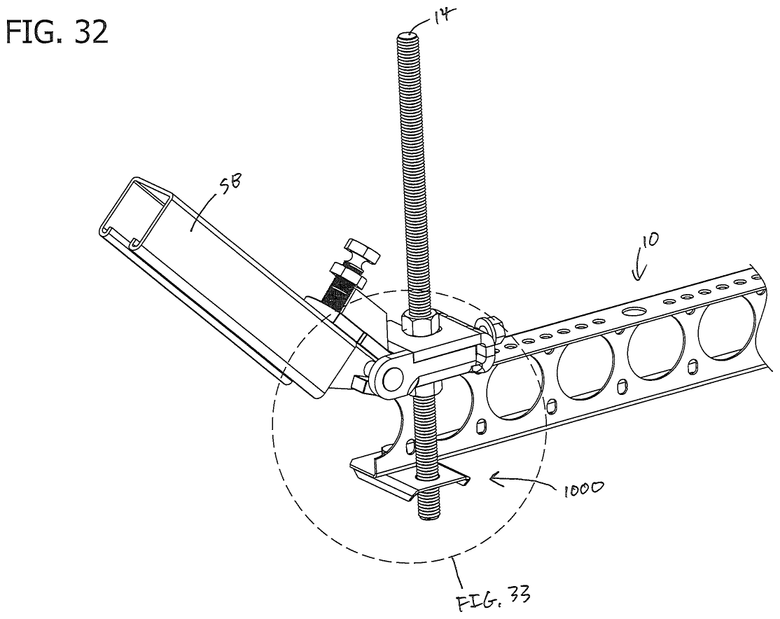

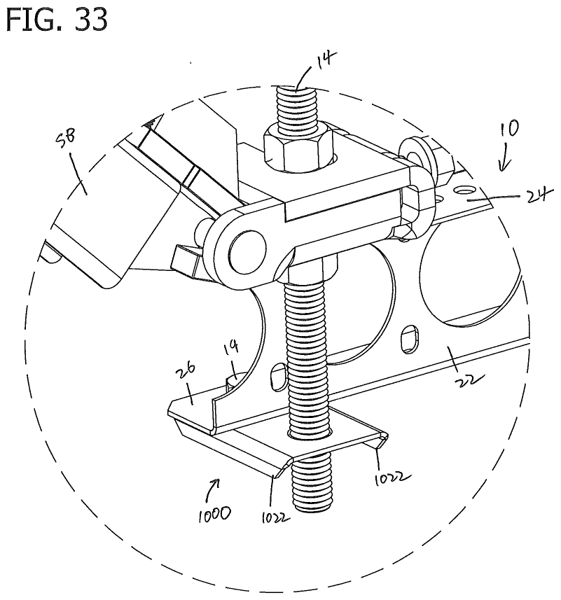

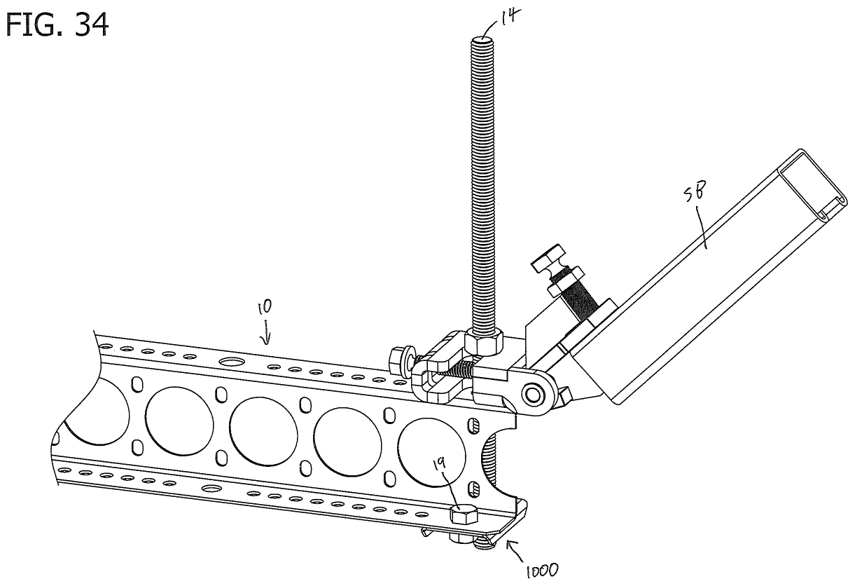

Referring to FIGS. 32-34, the hanger assembly 12 can also include seismic braces or restraints SB connected to the support bracket 10 so that the hanger assembly can be used to support non-structural components in seismic applications. For example, the support bracket 10 can be connected to a seismic brace or restraint such as those described by U.S. Pat. Nos. 6,273,372 and/or 7,654,043, the entireties of which are incorporated herein by reference. In order to use the support bracket 10, described above, in a seismic loading condition, the support bracket needs to be reinforced or strengthened, typically, at or near the point of connection between the support rod 14 and the support bracket—the point on the support bracket most likely to fail (e.g., tear, bend, deform, break, etc.) because it carries the greatest amount of load. A variety of different reinforcement braces, described below, can be attached to the support bracket 10 so that the support bracket may be used in a seismic application. Generally, these reinforcement braces provide an additional connection between the support bracket 10 and the support rod 14 (e.g., connecting the web 22 and/or lower flange 26 to the support rod) and/or strength the support bracket around the point of connection between the support rod and support bracket to provide the necessary reinforcement. It is understood that the various reinforcement braces described below may also be used in a non-seismic situation to increase the load carrying capacity of the support bracket 10, and therefore the hanger assembly 12.

Referring to FIGS. 32-35, one embodiment of a reinforcement brace for the support bracket 10 is generally shown at 1000. The reinforcement brace 1000 is configured to extend between and connect the lower flange 26 of the support bracket 10 to the support rod 14. The reinforcement brace 1000 includes a body 1020 having a generally horizontal web 1024 and generally vertical opposite side flanges 1022. The web 1024 and side flanges 1022 are generally planar. The web 1024 is generally rectangular with opposite side edge margins and opposite end edge margins. Each side flange 1022 extends downward from one of the side edge margins of the web 1024 to a free end. Each side flange 1022 is generally perpendicular to the web 1024. The web 1024 defines a longitudinal axis extending between the opposite end edge margins. The web 1024 defines two fastener openings 1030 longitudinally spaced apart along the web. As explained in more detail below, one fastener opening 1030 is used to connect the reinforcement brace 1000 to the lower flange 26 of the support bracket and the other fastener opening is used to connect the reinforcement brace to the support rod 14. As explained in more detail below, each fastener opening 1030 can receive either a fastener 19 or the support rod 14. The fastener openings 1030 may be the same size or different sizes. In the illustrated embodiment, the fastener openings 1030 are different sizes, with one opening 1030 sized to receive a ⅜ inch (1 cm) diameter fastener 19 or support rod 14 and the other opening sized to receive a ½ inch (⅓ cm) diameter fastener or support rod.

Referring to FIGS. 32-34, when the reinforcement brace 1000 is part of the hanger assembly 12, the reinforcement brace extends between and connects the lower flange 26 of the support bracket 10 to the support rod 14. The reinforcement brace 1000 underlies and engages a portion of the lower flange 26, specifically, a top surface of the web 1024 engages the bottom surface of the lower flange 26. One fastener opening 1030 defined by the web 1024 aligns with one of the accessory attachment openings 30 on the lower flange 26 such that a fastener 19 can be inserted therein to secure the reinforcement brace 1000 to the support bracket 10. The other fastener opening 1030 aligns with and receives the support rod 14 so that nuts (not shown) can be used to secure the reinforcement brace 1000 to the support rod 14, as described above. In this manner, the reinforcement brace 1000 connects the lower flange 26 to the support rod 14 to provide an additional connection between the support bracket 10 and the support rod and allows the support bracket to be used in seismic application (e.g., use of the reinforcement brace increases the strength of the connection between the support bracket and support rod). If the webs 1024 defines fastener openings of different sizes 1030, the reinforcement brace 1000 is positioned (e.g., rotated 180 degrees) such that the fastener opening corresponding to the size of the support rod 14 is connected to the support rod. The fastener opening 1030 that aligns with the accessory attachment opening 30 does not have to be the same size as the accessory attachment opening and a fastener 19 sized to be inserted through the smaller of the two openings (either the fastener opening or the accessory attachment opening) is sufficient to connect the reinforcement brace 1000 to the support bracket 10. Thus, the reinforcement brace 1000 is able form a close fitting relationship with support rods 14 of various sizes. Alternatively, the reinforcement brace 1000 can extend between and connect the upper flange 24 to the support rod 14 if the support rod is connected to the lower flange 26 of the support bracket 10.

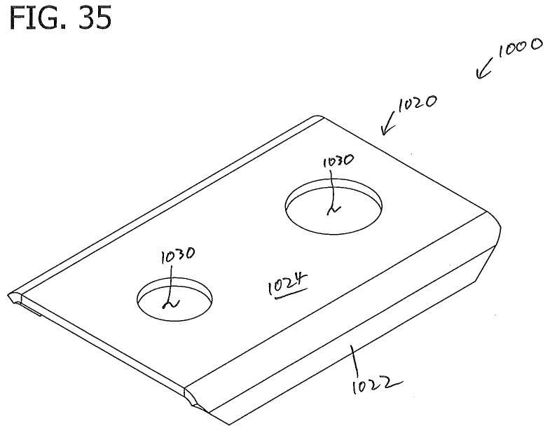

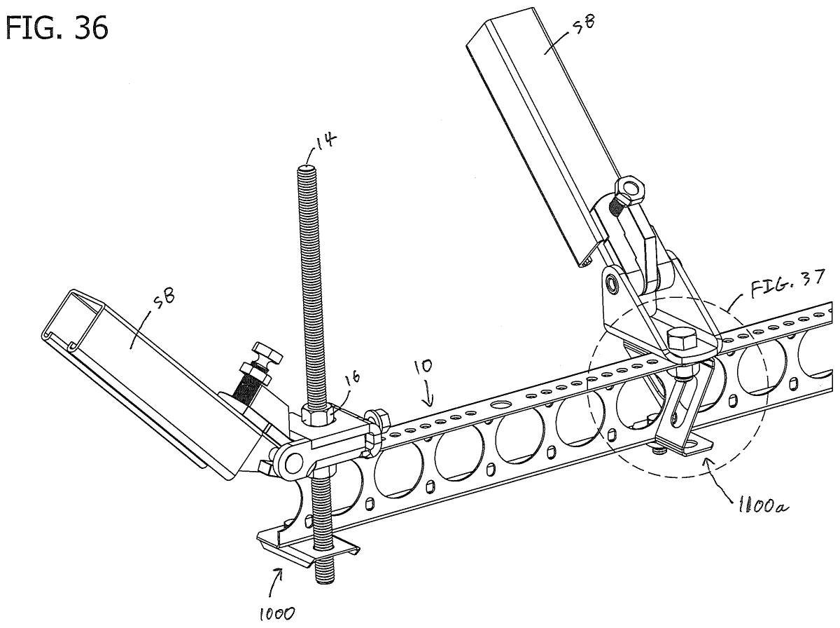

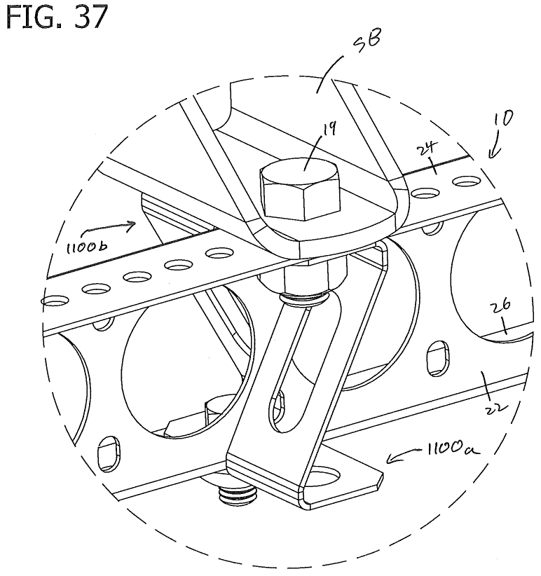

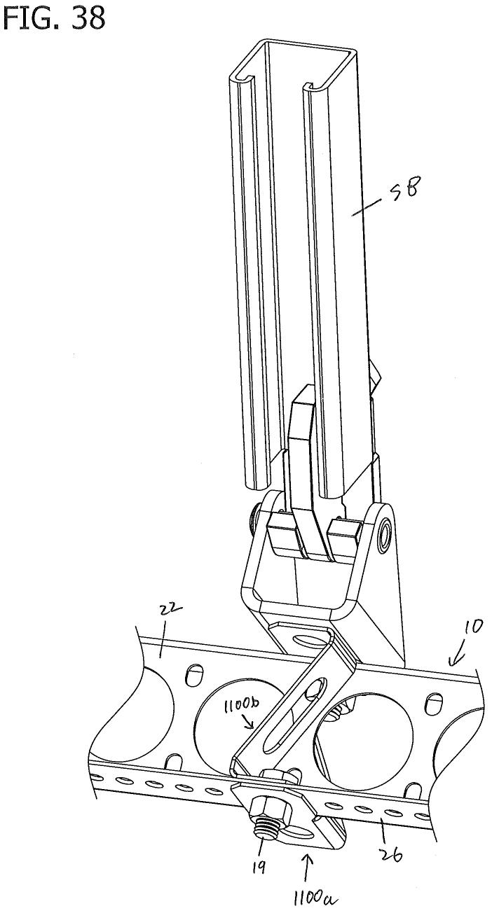

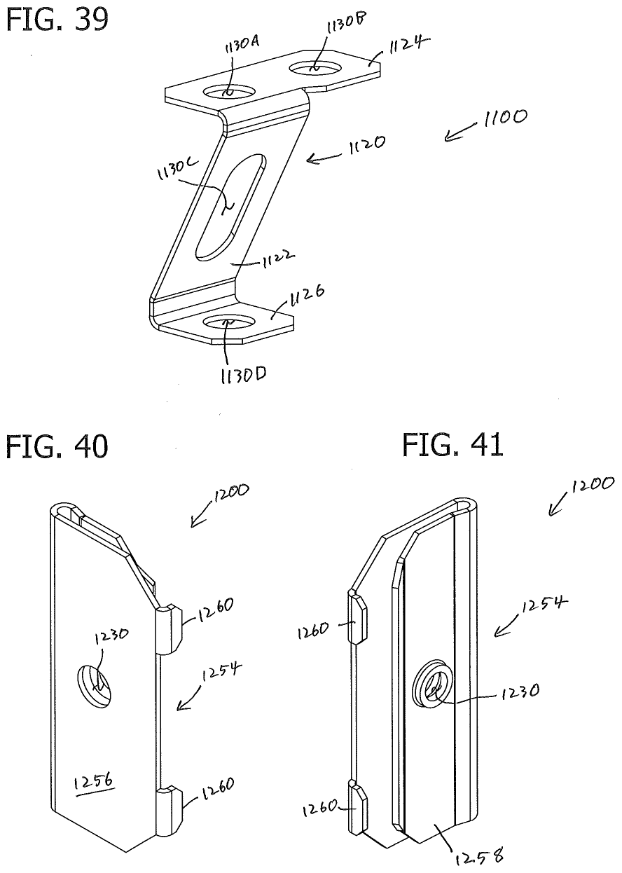

Referring to FIGS. 36-39, another embodiment of a reinforcement brace for the support bracket 10 is generally shown at 1100. The reinforcement brace 1100 is configured to extend partially along the support bracket to reinforce the connection between the support bracket 10 and the support rod 14. The reinforcement brace 1100 includes a body 1120 having a upper flange 1124, a web 1122 and a lower flange 1126. The upper flange 1124 is generally rectangular and has opposite side edge margins, opposite end edge margins, a top face and a bottom face. The upper flange 1124 is generally planar and extends generally horizontally. The upper flange 1124 defines two fastener openings 1130A and 1130B, respectively, longitudinally spaced apart between the opposite end edge margins. The first fastener opening 1130a is configured to align and receive a support rod 14. The second fastener opening 1130b is configured to align with one of the accessory attachment openings 30 on either the top or lower flange 24, 26 of the support bracket.

The web 1122 extends from a portion of one of the side edge margins of the upper flange 1124 downward at an angle to the vertical such that the web extends underneath the upper flange. The web 1122 is generally rectangular and has opposite upper and lower edge margins, opposite front and rear edge margins, a left face and a right face. The upper edge margin is connected to a portion of one of the side edge margins of the upper flange 1124. Accordingly, the width of the web 1122 (between the front and rear edge margins) is less than the length of the upper flange 1124 (between the opposite end edge margins). In the illustrated embodiment, the width of the web 1122 is about half the length of the upper flange. The lower edge margin of the web 1122 is positioned vertically below the opposite side edge margin of the upper flange 1124. The rear edge margin of the web 1122 is configured to engage the web 22 of the support bracket 10. The web 1122 of the reinforcement brace 1100 defines a fastener opening 1130c that is configured to align and receive a support rod 14. Accordingly, the fastener opening 1130c on the web 1122 is aligned with the fastener opening 1130a on the upper flange 1124. The fastener opening 1130c has a slot shape that extends vertically along the web 1122. As explained below, the web 1122 is configured so that it does not obstruct a non-structural component opening 28 on the support bracket 10.

The lower flange 1126 extends from the lower edge margin of the web 1122 to a free end. The lower flange 1126 is generally rectangular and has opposite front and rear edge margins, a top face and a bottom face. The rear edge margin is configured to engage the web 22 of the support bracket 10. The lower flange 1122 is generally planar and extends generally horizontally under the web 1122. Thus, in the illustrated embodiment, the reinforcement brace 1100 has a Z-shape. The width of the lower flange 1126 is generally the same as the width of the web 1122. The lower flange 1126 and upper flange 1124 are generally parallel to one another and lie in separate spaced apart planes. The distance between the top and lower flanges 1124, 1126 defines a height of the reinforcement device 1100 (set by the web 1122), the height being generally the same as the height H1 of the support bracket 10. The lower flange 1126 of the reinforcement brace 1100 defines a fastener opening 1130d that is configured to align and receive a support rod 14. Accordingly, the fastener opening 1130d on the lower flange 1126 is aligned (e.g., vertically aligned) with the fastener openings 1130a, 1130b on the top and webs 1124, 1122. Like fastener opening 1130a, fastener opening 1130d has a circular or hole shape.

As shown in FIGS. 36-38, the reinforcement brace 1100 extends around about half or one side of the support bracket 10 when attached to the support bracket. In the illustrated embodiment, two reinforcement braces 1100a and 1100b are attached to either side of the support bracket. In another embodiment, only one reinforcement brace 1100 is used. When attached to the support bracket 10, reinforcement brace 1100a is upside down (e.g., rotated 180 degrees). The bottom face of the upper flange 1124 overlies and engages the bottom face of the lower flange 26 of the support bracket 10, the bottom face of the lower flange 1126 overlies and engages the bottom face of the upper flange 24, and the rear edge margins of the central and lower flanges 1122, 1126 overly and engage the rear face of the web 22. The fastener opening 1130b on the upper flange 1124 aligns with one of the accessory attachment openings 30 on the lower flange 26 such that a fastener 19 (e.g., bolt) can be inserted therein to secure the reinforcement brace 1100a to the lower flange of the support bracket 10. Similarly, the fastener openings 1130a, 1130c, 1130d are aligned (e.g., vertically aligned) with one of the rod couplers 50 (or accessory attachment openings 30) on the upper flange 24 such that a support rod 14 can be inserted therein and extend through each of the fastener openings. In the illustrated embodiment, instead of a support rod 14, a fastener 19 is only inserted through the fastener opening 1130d on the lower flange 1126 to connect the reinforcement brace 1100 to the upper flange 24 of the support bracket.

When attached to the support bracket 10, reinforcement brace 1100b is upright. The bottom face of the upper flange 1124 overlies and engages the top face of the upper flange 24 of the support bracket 10, the bottom face of the lower flange 1126 overlies and engages the top face of the lower flange 26, and the rear edge margins of the central and lower flanges 1122, 1126 overly and engage the front face of the web 22. The fastener opening 1130b on the upper flange 1124 aligns with the same rod coupler 50 (or accessory attachment opening 30) on the upper flange 24 aligned with the reinforcement brace 1100a (specifically, aligned with fastener openings 1130a, 1130c, 1130d of reinforcement brace 1100a) such that the same support rod 14 (or fastener 19) can be used to connect the reinforcement braces 1100a, 1100b to the upper flange 24 of the support bracket 10. Similarly, the fastener openings 1130a, 1130c, 1130d of reinforcement brace 1100b are aligned (e.g., vertically aligned) with the same accessory attachment openings 30 on the lower flange 26 aligned the reinforcement brace 1100a (specifically, aligned with fastener opening 1130b of the reinforcement brace 1100a) such that the same fastener 19 (or support rod 14) can be used to connect the reinforcement braces 1100a, 1100b to the lower flange 26 of the support bracket 10. When the reinforcement braces 1100a, 1100b are attached to the support bracket 10, the webs 1122 extend at an angle between adjacent non-structural support openings 28 of the support bracket 10 so that the reinforcement braces do not obstruct the non-structural support openings. When attached to the support bracket 10, the reinforcement brace 1100 strengths the support bracket at the point of connection between the support rod and support bracket.

Referring to FIGS. 40-43, another embodiment of a reinforcement brace for the support bracket 10 is generally shown at 1200. In this embodiment, the reinforcement brace 1200 is configured to strengthen the support bracket 10. More specifically, the reinforcement brace 1200 is configured to strengthen the weakest part of the web 22 of the support bracket 10 near the connection with the support rod 10. Because the web 22 carries the most amount of load at this point and is at its weakest because of the non-structural component openings 28, the web 22 will typically fail at this location (near the support rod 10).

The reinforcement brace 1200 includes a clip 1254 configured to slide over the left or right edge margins of the web 22 of the support bracket. The clip 1254 includes a front jaw 1256 and a rear jaw 1258 coupled together and configured to receive a portion of the web 22 there-between. The front and rear jaws 1256, 1258 are connected together at a first side edge margin and are resiliently deflectable with respect to one another. The front and rear jaws 1256, 1258 are generally planar. Two insertion tabs 1260 extend generally horizontally in a rearward direction from a second side edge margin of the front jaw 1256 opposite the first side edge margin. Each insertion tab 1260 is configured to extend through an accessory attachment opening 30 on the web 22 of the support bracket 10 to help hold the reinforcement brace 1200 on the web. The insertion tabs 1260 are generally perpendicular to the front jaw 1256. The jaws 1256, 1258 define aligned fastener opening 1230 configured to receive a fastener 19 therein to secure the clip 1254 to the support bracket 10. The fastener opening 1230 in the rear jaw 1258 may be threaded.

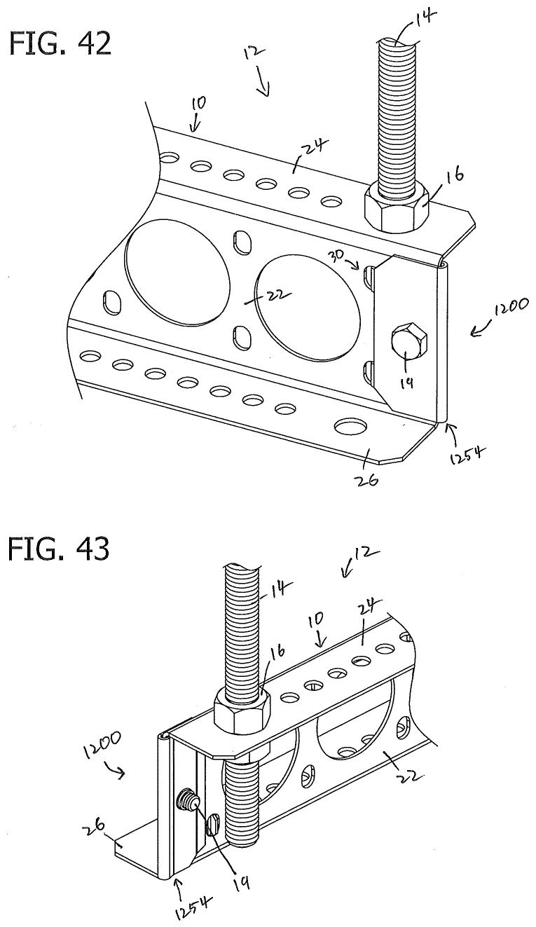

As shown in FIGS. 42 and 43, when the reinforcement brace 1200 is attached to the support bracket 10, the front jaw 1256 overlies and engages the front face of the web 22, the rear jaw 1258 overlies and engages the rear face of the web, and each insertion tab 1260 extends into one of the accessory attachment openings 30. When the clip 1254 is slid onto the support bracket 10, the engagement of the web 22 resiliently deflects the front and rear jaws 1256, 1258 away from each other. Once the insertion tabs 1260 align with the accessory attachment openings 30 on the web 22, the front and rear jaws 1256, 1258 return to their original position which results in the insertion tabs being moved into the accessory attachment openings to help hold the clip on the web. In the illustrated embodiment, the insertion tabs 1260 extend through the accessory attachment openings 30 positioned between the at least partially defined non-structural component opening 28 at the left or right edge margin of the web 22 and the adjacent non-structural component opening. In other embodiments, the clip 1254 may extend over more of the web 22 to other accessory attachment openings. The clip 1254 is secured to the support bracket 10 through the force applied by a fastener 19 extending through the fastener openings 1230. The fastener opening 1230 on the rear jaw 1258 may be threaded to secure the fasteners 19 to the clip 1254 or nuts (not shown) can be used. The fastener openings 1230 are positioned on the clip 1254 such that the fastener 19 received therein extends through the at least partially defined non-structural component opening 28. When the fastener 19 is tightened, the clip 1254 compresses the web 22 between the front and rear jaws 1256, 1258 to reinforce the web.

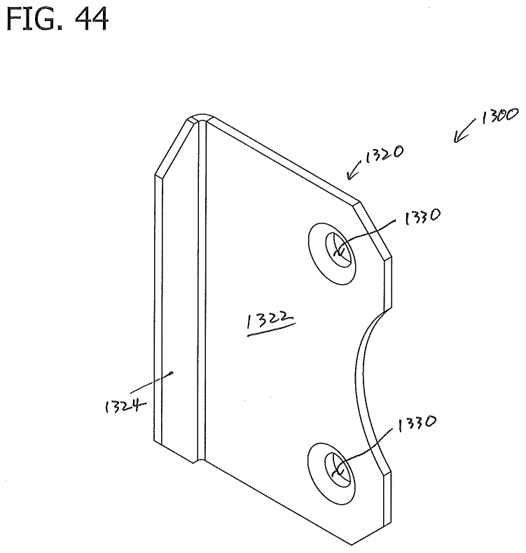

Referring to FIGS. 44-46, another embodiment of a reinforcement brace for the support bracket 10 is generally shown at 1300. In this embodiment, the reinforcement brace 1300 is configured to strengthen the support bracket 10. More specifically, the reinforcement brace 1300 is configured to strengthen the weakest part of the web 22, as described above. The reinforcement brace 1300 includes a body 1320 having a first flange 1322 and a second flange 1324. The first and second flanges 1322, 1324 are generally planar and extend generally vertically. The first flange 1322 is generally rectangular and has opposite left and right edge margins, opposite upper and lower edge margins, a front face and a rear face. The right edge margin defines a free end of the first flange 1322. The first flange 1322 defines two fastener openings 1330 adjacent the right edge margin configured to align with accessory attachment openings 30 on the web 22. The fastener openings 1330 can be threaded, as described above. The right edge margin of the first flange 1322 can be sized and shaped to correspond to the size and shape of the non-structural component openings 28 (specifically, the first complete non-structural component opening adjacent either end of the support bracket 10) so that when the reinforcement brace 1300 is connected to the support bracket, the first flange does not obstruct the non-structural component opening.

The second flange 1324 extends forward from the left edge margin of the first flange 1322 to a free end. In the illustrated embodiment, the second flange 1324 is generally perpendicular to the first flange 1322. The second flange 1324 is generally rectangular and has opposite upper and lower edge margins, opposite front and rear edge margins, a left face and a right face. The rear edge margin of the second flange 1324 is connected to the left edge margin of the first flange 1322 and the front edge margin of the second flange defines the free end. The second flange 1324 rigidifies the first flange 1322 to inhibit the first flange from bending.

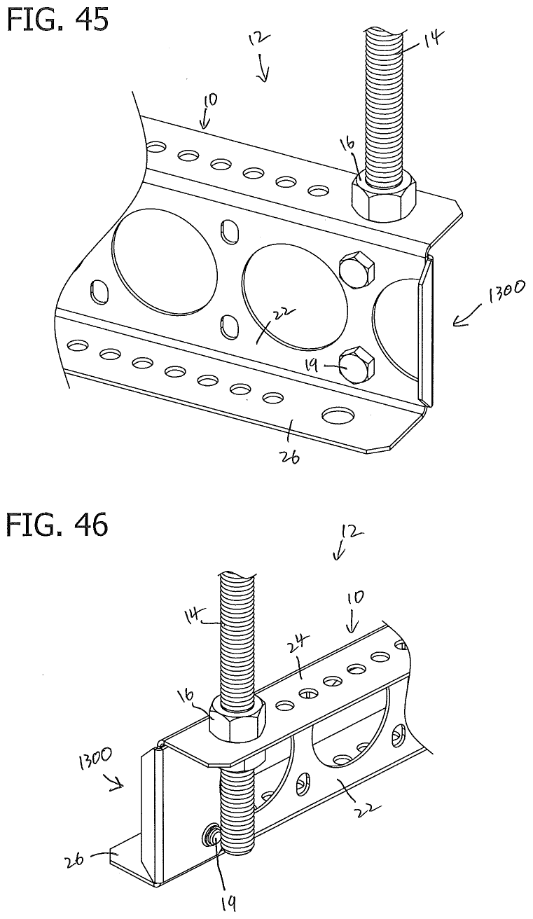

The reinforcement brace 1300 is configured to overlie and engage the web 22 of the support bracket at one end thereof. As shown in FIGS. 45 and 46, the first flange 1322 overlies and engages the web 22 of the support bracket and the second flange 1324 extends around and engages the end edge margin (e.g., right edge margin as shown) of the web. The reinforcement brace 1300 can be attached to either the front or rear face of the web 22. When the reinforcement brace 1300 is attached to the support bracket 10, the right edge margin of the first flange 1322 does not obstruct one of the non-structural component openings 28 of the support bracket. The fastener openings 1330 on the first flange 1322 align with the accessory attachment openings 30 on the web 22 such that a fastener 19 can be inserted therein to the secure the reinforcement brace 1300 to the support bracket 10. The fastener openings 1330 may be threaded to secure the fasteners 19 or nuts (not shown) can be used. When attached to the support bracket 10, the reinforcement brace 1300 strengthens the web 22.

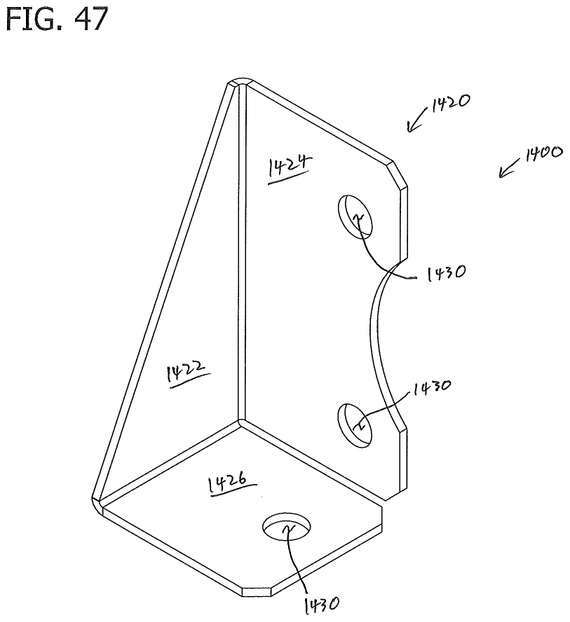

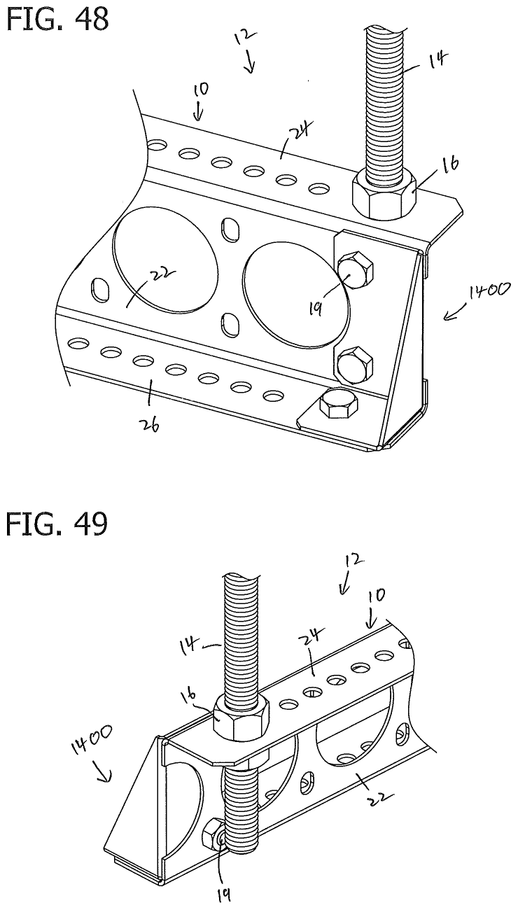

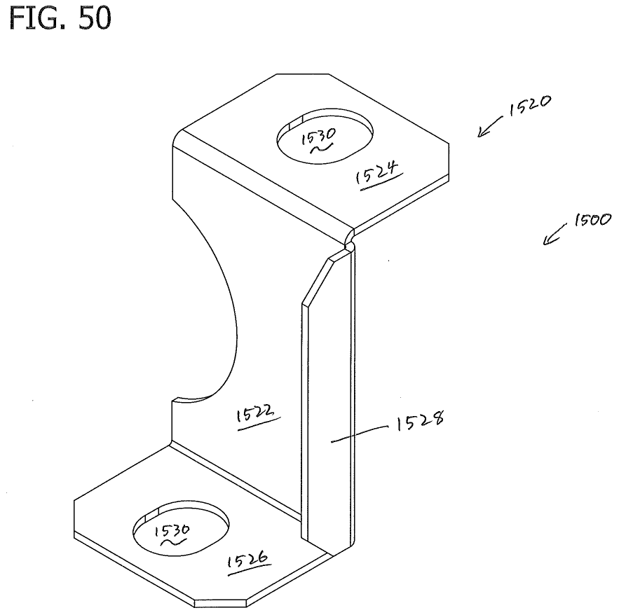

Referring to FIGS. 47-49, another embodiment of a reinforcement brace for the support bracket 10 is generally shown at 1400. In this embodiment, the reinforcement brace 1400 is configured to strengthen the support bracket 10. More specifically, the reinforcement brace 1400 is configured to strengthen the weakest part of the web 22, as described above. The reinforcement brace 1400 includes a body 1420 having a web 1422, a side flange 1424 and a lower flange 1426. The web 1422 is generally planar and extends generally vertically. The web 1422 is generally triangular and has a lower edge margin, a rear edge margin, an angled upper edge margin, a left face and a right face. The side flange 1424 extends rightward from the side edge margin of the web 1422 to a free end. The side flange 1424 is generally planar and is generally perpendicular to the web 1422. The side flange 1424 is generally rectangular and has opposite left and right edge margins, opposite upper and lower edge margins, a front face and a rear face. The left edge margin of the side flange 1424 is connected to the side edge margin of the web 1422 and the right edge margin of the side flange defines the free end. The side flange 1424 defines two fastener openings 1430 adjacent the right edge margin (e.g., free end) configured to align with accessory attachment openings 30 on the web 22. The right edge margin of the side flange 1424 can be sized and shaped to correspond to the size and shape of the non-structural component openings 28 (specifically, the first complete non-structural component opening adjacent either end of the support bracket 10) so that when the reinforcement brace 1400 is connected to the support bracket, the side flange does not obstruct the non-structural component opening. The lower flange 1426 extends rightward from the lower edge margin of the web 1422 to a free end. The lower flange 1426 is generally planar and is generally perpendicular to the web 1422 and side flange 1424. The lower flange 1426 is generally rectangular and has opposite left and right edge margins, opposite front and rear edge margins, a top face and a bottom face. The left edge margin of the lower flange 1426 is connected to the lower edge margin of the web 1422 and the right edge margin of the lower flange defines the free end. The lower flange 1426 defines a fastener opening adjacent the right edge margin (e.g., free end) configured to align with one of the rod couplers 50 or accessory attachment openings 30 on the bottom or upper flanges 24, 26. The reinforcement brace 1400 shown in FIG. 47 is configured to attach to the support bracket 10 at the right end thereof. The reinforcement brace 1400 may also be configured to attach to the support bracket 10 at the left end thereof, as shown in FIGS. 48 and 49. In this embodiment, the side and lower flanges 1424, 1426 extend leftward from the web 1522.

The reinforcement brace 1400 is configured to overlie and engage the web 22 and lower flange 26 of the support bracket 10. As shown in FIGS. 48 and 49, when the reinforcement brace 1400 is connected to the support bracket 10, the bottom face of the lower flange 1426 overlies and engages the top face of the lower flange 26 of the support bracket 10 and the rear face of the side flange 1424 overlies and engages the front face of the web 22. Alternatively, the reinforcement brace 1400 can be attached to the upper flange 24 of the support bracket 10 such that the lower flange 1426 engages the bottom face of the upper flange of the support bracket and the side flange 1424 engages the rear face of the web 22. When the reinforcement brace 1400 is attached to the support bracket 10, the right edge margin of the side flange 1424 does not obstruct one of the non-structural component openings 28 of the support bracket. The fastener openings 1430 on the side flange 1424 align with the accessory attachment openings 30 on the web 22 such that a fastener 19 can be inserted therein to the secure the reinforcement brace 1400 to the support bracket 10. The fasteners 19 are preferably secured with a nut 16. In other embodiments, the one or more of the fastener openings 1430 may be threaded to secure the fastener 19, as described above. Similarly, the fastener opening 1430 on the lower flange 1426 aligns with the rod coupler 50 or one of the accessory attachment openings 30 on either the top or lower flange 24, 26 such that a fastener 19 or a support rod 14 (not shown) can be inserted therein. When attached to the support bracket 10, the reinforcement brace 1400 strengthens the web 22 and the lower flange 26.

Referring to FIGS. 50-52, another embodiment of a reinforcement brace for the support bracket 10 is generally shown at 1500. In this embodiment, the reinforcement brace 1500 is configured to strengthen the support bracket 10. More specifically, the reinforcement brace 1500 is configured to strengthen the weakest part of the web 22, as described above, and to reinforce the connection between the support bracket 10 and the support rod 14. The reinforcement brace 1500 includes a body 1520 having a web 1522, an upper flange 1524, a lower flange 1526 and a side flange 1528. The web 1522 is generally rectangular and has opposite upper and lower edge margins, opposite right and left edge margins, a front face, and a rear face. The web 1522 is extends generally vertically and has a height extending between the upper and lower edge margins that is generally the same as the height H1 of the web 22 of the support bracket 10. The left edge margin of the web 1522 can be sized and shaped to correspond to the size and shape of the non-structural component openings 28 (specifically, the first complete non-structural component opening adjacent either end of the support bracket 10) so that when the reinforcement brace 1500 is connected to the support bracket, the web does not obstruct the non-structural component opening. The side flange 1528 extends forward from the right edge margin of the web 1522 to a free end. In the illustrated embodiment, the side flange 1528 is generally perpendicular to the web 1522. The side flange 1528 is generally rectangular and has opposite upper and lower edge margins, opposite front and rear edge margins, a left face and a right face. The rear edge margin of the side flange 1528 is connected to the right edge margin of the web 1522 and the front edge margin of the second flange defines the free end. The side flange 1528 rigidifies the web 1522 to inhibit the web from bending. The illustrated reinforcement brace 1500 is configured to attach to the support bracket 10 at the right end thereof. The reinforcement brace 1500 may also be configured to attach to the support bracket 10 at the left end thereof. In this embodiment, the features of the respective left and right edge margins of the web 1522 described above would be switched such that the side flange 1528 extends from the left edge margin and the right edge margin is sized and shaped to not obstruct a non-structural component opening 28.

The upper flange 1524 extends rearward from the upper edge margin of the web 1522 to a free end. The upper flange 1524 is generally planar and extends generally horizontally. The upper flange 1524 is generally rectangular and has opposite left and right (e.g., side) edge margins, opposite front and rear (e.g., end) edge margins, a top face and a bottom face. The front edge margin of the upper flange 1524 is connected to the upper edge margin of the web 1522 and the rear edge margin of the upper flange defines the free end. The upper flange 1524 defines a fastener opening 1530 configured to align with one of the rod couplers 50 or accessory attachment openings 30 on the upper flange 24 of the support bracket 10. In the illustrated embodiment, the fastener opening 1530 is a slot. The lower flange 1526 extends forward from the lower edge margin of the web 1522 to a free end. The lower flange 1526 is generally planar and extends generally horizontally. The lower flange 1526 is generally rectangular and has opposite left and right (e.g., side) edge margins, opposite front and rear (e.g., end) edge margins, a top face and a bottom face. The rear edge margin of the lower flange 1526 is connected to the lower edge margin of the web 1522 and the front edge margin of the lower flange defines the free end. The lower flange 1526 defines a fastener opening 1530 configured to align with one of the rod couplers 50 or accessory attachment openings 30 on the lower flange 26 of the support bracket 10. In the illustrated embodiment, the fastener opening 1530 is a slot. Thus, in the illustrated embodiment, the reinforcement brace 1500 has a Z-shape. The lower flange 1526 and upper flange 1524 are generally parallel to one another and lie in separate spaced apart planes.

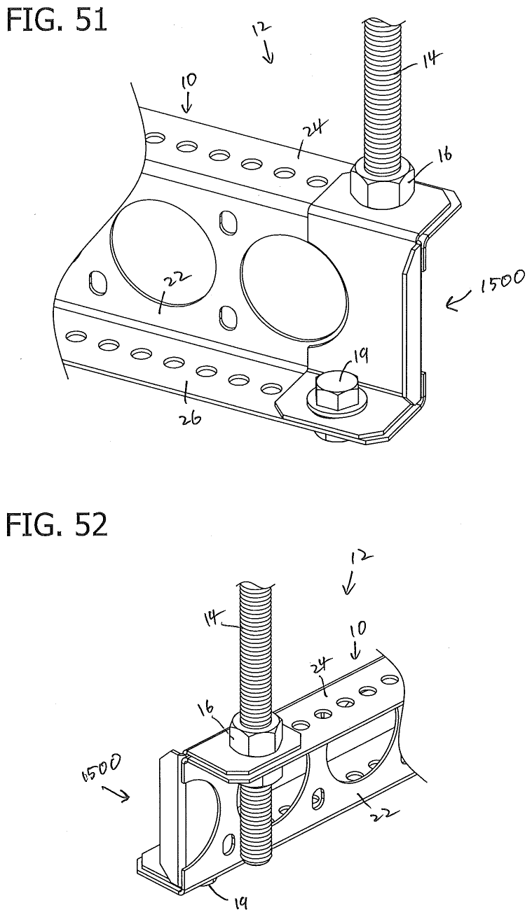

The reinforcement brace 1500 is configured to overlie and engage the web 22, upper flange 24 and lower flange 26 of the support bracket 10. As shown in FIGS. 51 and 52, when the reinforcement brace 1500 is connected to the support bracket 10, the bottom face of the lower flange 1526 overlies and engages the top face of the lower flange 26 of the support bracket 10, the rear face of the web 1522 overlies and engages the front face of the web 22, and the bottom face of the upper flange 1524 overlies and engages the top flace of the upper flange 24. Alternatively, the reinforcement brace 1500 can be attached to the other side (e.g., rear side) of the support bracket 10 such that the reinforcement brace overlies and engages the bottom face of the upper flange 24, the rear face of the web 22, and the bottom face of the lower flange 26. When the reinforcement brace 1500 is attached to the support bracket 10, the left edge margin of the web 1522 does not obstruct one of the non-structural component openings 28 of the support bracket. The fastener opening 1530 on the upper flange 1524 aligns with one of the rod couplers 50 or accessory attachment openings 30 on the upper flange 24 such that a fastener 19 (not shown) or support rod 14 can be inserted therein to the secure the reinforcement brace 1500 to the support bracket 10. Similarly, the fastener opening 1530 on the lower flange 1526 aligns with one of the rod couplers 50 or accessory attachment openings 30 on the lower flange 26 such that a fastener 19 or a support rod 14 (not shown) can be inserted therein. The fasteners 19 and/or support rods are preferably secured with nuts 16. When attached to the support bracket 10, the reinforcement brace 1500 strengthens the web 22 and the connection between the support bracket and support rod 14.

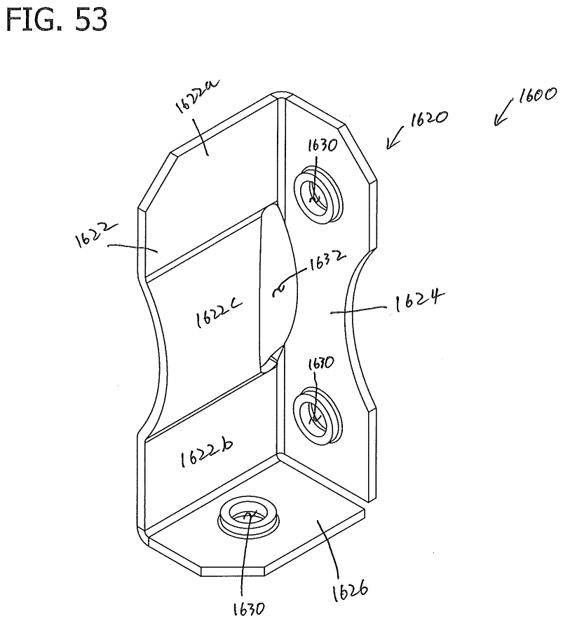

Referring to FIGS. 53-55, another embodiment of a reinforcement brace for the support bracket 10 is generally shown at 1600. In this embodiment, the reinforcement brace 1600 is configured to strengthen the support bracket 10. More specifically, the reinforcement brace 1600 is configured to strengthen the web 22. The reinforcement brace 1600 includes a body 1620 having a web 1622, a side flange 1624 and a lower flange 1626. The web 1622 extends generally vertically and has an upper planar portion 1622a, a lower planar portion 1622b, and a center portion 1622c extending between and interconnection the upper and lower portions. The center portion 1622c is arranged so that it does not obstruct one of the non-structural component openings 28 when the reinforcement brace 1600 is attached to the support bracket 10. The center portion 1622c is sized and shaped to correspond to the size and shape of the non-structural component openings 28. In the illustrated embodiment, the center portion 1622 is curved or bent such that the entire center portion is positioned radially outward from a corresponding non-structural component opening (e.g., the center portion's radius of curvature is greater than the non-structural component's radius). The web 1622 is generally rectangular and has opposite upper and lower edge margins, opposite front and rear edge margins, a left face and a right face.

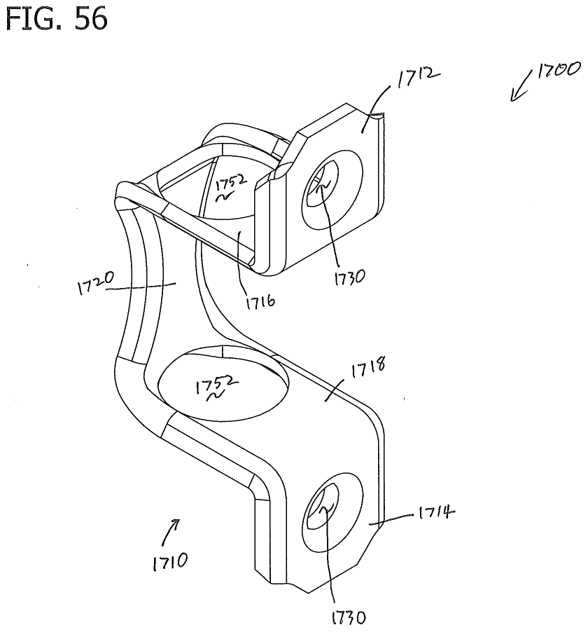

The side flange 1624 extends rightward from the rear edge margin of the web 1622 to a free end. The side flange 1624 is generally planar and is generally perpendicular to the web 1622. The side flange 1624 is generally rectangular and has opposite left and right edge margins, opposite upper and lower edge margins, a front face and a rear face. The left edge margin of the side flange 1624 is connected to the rear edge margin of the web 1622 and the right edge margin of the side flange defines the free end. The side flange 1624 defines two fastener openings 1630 configured to align with accessory attachment openings 30 on the web 22. The left and right edge margins of the side flange 1624 can each be sized and shaped to correspond to the size and shape of the non-structural component openings 28 so that when the reinforcement brace 1600 is connected to the support bracket 10, the side flange does not obstruct the non-structural component openings. Preferably, the left edge margin (or a portion thereof) of the side flange 1624 aligns with the center portion 1622c of the web 1622. Together, the central and side flanges 1622, 1624 define an opening 1632 in the body 1620 of the reinforcement brace 1600. More specifically, the left side edge margin of the side flange 1624 and the upper, lower, and central portions 1622a, 1622b, 1622c of the web 1622 define the opening 1632. The center portion 1622c has a width extending between the opening 1632 and the front edge margin of the web 1622 that can be generally any size greater than zero but equal to or less than the width of the web 1622. For example, the reinforcement brace 1600 illustrated in FIG. 55 has center portion 1622c that has a greater width than the center portion 1622c of the reinforcement brace 1600 illustrated in FIG. 53. Because of the opening 1632, the upper and lower portions 1622a, 1622b of the web are connected to the side flange 1624.

The lower flange 1626 extends rightward from the lower edge margin of the web 1522 to a free end. The lower flange 1626 is generally planar and is generally perpendicular to the web 1622 and side flange 1624. The lower flange 1626 is generally rectangular and has opposite left and right edge margins, opposite front and rear edge margins, a top face and a bottom face. The left edge margin of the lower flange 1626 is connected to the lower edge margin of the web 1622 and the right edge margin of the lower flange defines the free end. The lower flange 1626 defines a fastener opening configured to align with one of the rod couplers 50 or accessory attachment openings 30 on the bottom or upper flanges 24, 26. The reinforcement brace 1600 is configured to attach to the support bracket 10 at any longitudinal position that is between adjacent non-structural component openings 28.

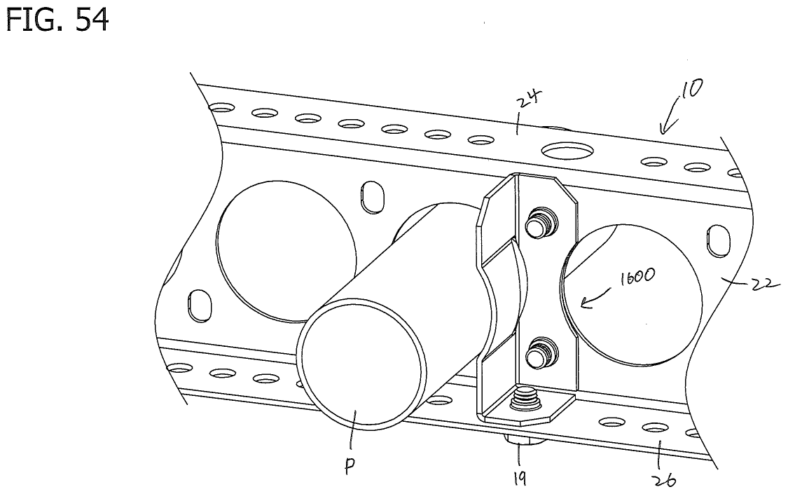

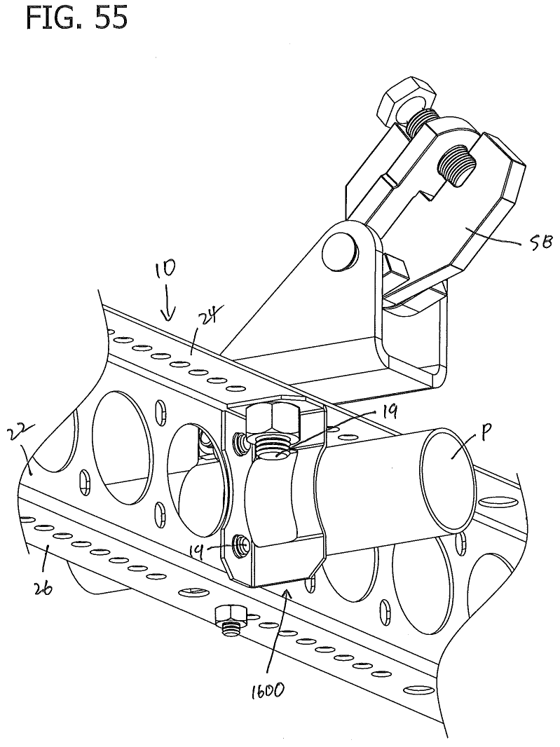

The reinforcement brace 1600 is configured to overlie and engage the web 22 and top or lower flange 24, 26 of the support bracket 10. As shown in FIG. 54, when the reinforcement brace 1600 is connected to the support bracket 10, the bottom face of the lower flange 1626 overlies and engages the top face of the lower flange 26 of the support bracket 10 and the rear face of the side flange 1624 overlies and engages the front face of the web 22. Alternatively, the reinforcement brace 1600 can be attached to the upper flange 24 of the support bracket 10 such that the lower flange 1626 engages the bottom face of the upper flange of the support bracket and the side flange 1624 engages the rear face of the web 22 (FIG. 55). When the reinforcement brace 1600 is attached to the support bracket 10 between adjacent non-structural component openings 28, the center portion 1622c of the web 1622 and left and right edge margins of the side flange 1624 do not obstruct the non-structural component openings. Moreover, in the illustrated embodiment, the center portion 1622c does not contact a non-structural component, such as a pipe P, that extends through the corresponding non-structural component opening 28. In another embodiment, the center portion 1622 may contact the non-structural component. The fastener openings 1630 on the side flange 1622 align with the accessory attachment openings 30 on the web 22 such that a fastener 19 can be inserted therein to the secure the reinforcement brace 1600 to the support bracket 10. Similarly, the fastener opening 1630 on the lower flange 1626 aligns with one of the rod couplers 50 or accessory attachment openings 30 on either the top or lower flange 24, 26 such that a fastener 19 or a support rod 14 (not shown) can be inserted therein. The fastener openings 1630 may be threaded to secure the fasteners 19 or nuts (not shown) can be used. When attached to the support bracket 10, the reinforcement brace 1600 strengthens the web 22 and the top or lower flange 24, 26. The reinforcement brace 1600 may also strengthen the connection between the support bracket 10 and the support rod 14 if the reinforcement brace receives the support rod.

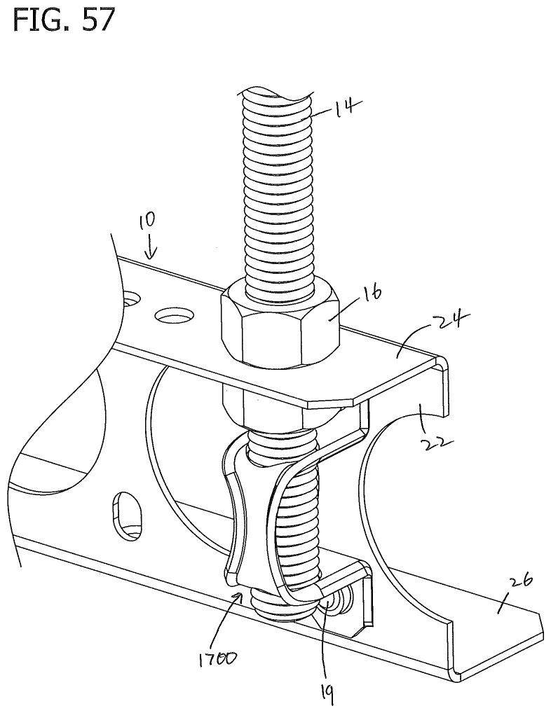

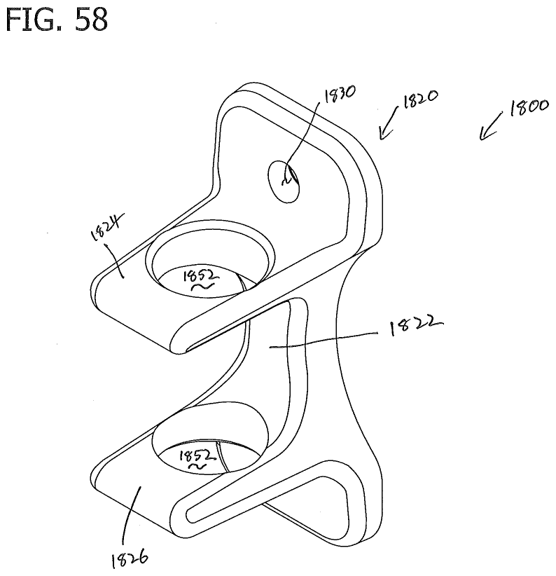

Referring to FIGS. 56 and 57, another embodiment of a reinforcement brace for the support bracket 10 is generally shown at 1700. The reinforcement brace 1700 is configured to extend between and connect the web 22 of the support bracket 10 to the support rod 14. The reinforcement brace 1700 includes a body 1710 having first and second end flanges 1712 and 1714, respectively, first and second intermediate flanges 1716 and 1718, respectively, and a web 1720. The web 1720 is generally planar and extends generally vertically between opposite upper and lower edge margins, the first and second intermediate flanges 1716, 1718 extend leftward from the upper and lower edge margins, respectively, of the web, the first end flange 1712 extends vertically upward from an end (e.g. left) edge margin of the first intermediate flange to a free end and the second end flange 1714 extend vertically downward from an end (e.g., left) edge margin of the second intermediate flange to a free end. Each flange 1712, 1714, 1716, 1718, 1720 is planar, has a generally rectangular shape and has opposite sides (e.g., side edge margins) extending between the ends of the flange. In the illustrate embodiment, the opposite sides of each flange 1712, 1714, 1716, 1718, 1720 are curled to stiffen the body 1710. The first and second intermediate flanges 1716, 1718 are generally parallel to one another and lie in separate spaced apart planes. The first and second end flanges 1712, 1714 are generally coplanar. Each of the first and second end flanges 1712, 1714 define a fastener opening 1730 configured to align with one of the accessory attachment openings 30 on the web 22. The fastener openings 1730 may be threaded. Each of the first and second intermediate flanges 1716, 1718 define a rod opening 1752 configured to receive the support rod 14. The rod openings 1752 are aligned (e.g., vertically aligned) and are configured to align with one of the rod couplers 50 (or accessory attachment openings 30) on the top or lower flanges 24, 26 of the support bracket 10. The opposite side edge margins of the web 1720 can each be sized and shaped to correspond to the size and shape of the non-structural component openings 28 so that when the reinforcement brace 1700 is connected to the support bracket 10, the side flange does not obstruct the non-structural component openings.

The reinforcement brace 1700 is configured to be attached to the web 22 of the support bracket 10 below or above one of the rod couplers 50 on either the top or lower flanges 24, 26. As shown in FIG. 57, when the reinforcement brace 1700 is connected to the support bracket 10, a left face of each end flange 1712, 1724 overlies and engages the rear face of the web 22 of the support bracket 10 and the rod openings 1752 are aligned (e.g., vertically aligned) with the one of the rod couplers 50 on the upper flange 24. Alternatively, the reinforcement brace 1700 can be attached to the front face of the web 22 such that the rod openings 1752 align (e.g., vertically align) with one of the rod couplers 50 on the lower flange 26. When the reinforcement brace 1700 is attached to the support bracket 10 between adjacent non-structural component openings 28, the opposite side edge margins of the web 1720 do not obstruct the non-structural component openings. The fastener openings 1730 on the first and second end flanges 1712, 1714 align with the accessory attachment openings 30 on the web 22 such that a fastener 19 can be inserted therein to the secure the reinforcement brace 1700 to the support bracket 10. The fastener openings 1730 may be threaded to secure the fasteners 19 or nuts (not shown) can be used. When attached to the support bracket 10, the reinforcement brace 1700 provides an additional connection between the support bracket 10 and the support rod 14 and, specifically, connects the web 22 to the support rod 14 to stiffen the web 22 and inhibit bending thereof.

The reinforcement braces 1000, 1100, 1200, 1300, 1400, 1500, 1600, 1700 may be formed from rigid metal, such as low carbon steel, stainless steel, aluminum, or other metals, or from other material, such as fiberglass or plastic. In one embodiment, the reinforcement braces 1000, 1100, 1200, 1300, 1400, 1500, 1600, 1700 are formed from a single piece of material, such as a metal blank that is stamped from a piece of sheet metal and bent into shape. In one non-limiting example, the reinforcement braces 1000, 1100, 1200, 1300, 1400, 1500, 1600, 1700 may be formed from 16 gauge (1.52 mm) sheet metal, 18 gauge (1.2 mm) steel sheet metal, or from 20 gauge (0.9 mm) steel sheet metal, although other gauges are within the scope of the present disclosure.

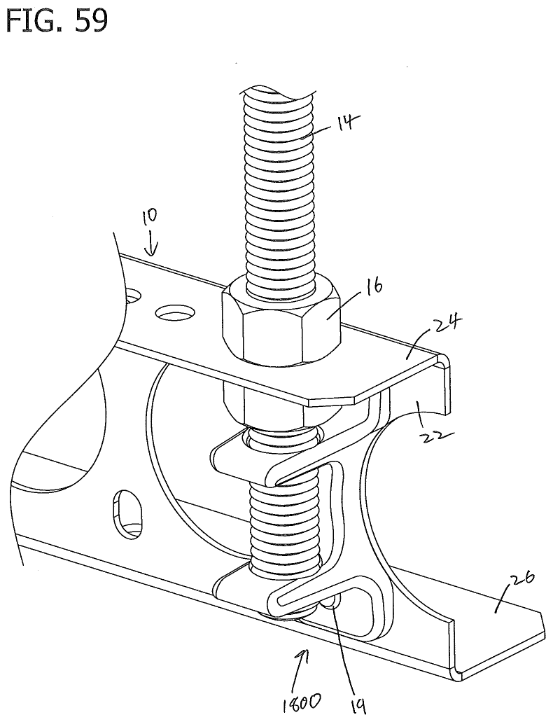

Referring to FIGS. 58-60, another embodiment of a reinforcement brace for the support bracket 10 is generally shown at 1800. Reinforcement brace 1800 is configured to extend between and connect the web 22 of the support bracket 10 to the support rod 14. Reinforcement brace 1800 is generally analogous to reinforcement brace 1700 but is preferably made from a single piece of casted material such as die cast metal, plastic or any other suitable material. The reinforcement brace 1800 includes a body 1820 having a base 1822 and first and second projections 1824 and 1826, respectively, extending forward from the base. The base 1820 is generally planar and extends generally vertically. The base is generally rectangular and has opposite upper and lower edge margins, opposite left and right (e.g., side) edge margins, a front face and a rear face. The first and second projections 1824, 1826 extend from the front face of the base 1820 to a free end and are generally perpendicular to the base. The first and second projections 1824, 1826 are generally planar and extend generally horizontally. Each projections 1824, 1826 has a generally rectangular shape and has opposite front and rear (e.g., end) edge margins, opposite left and right (e.g., side) edge margins, a top face and a bottom face. The rear edge margin of each projection 1824, 1826 is attached to the base and the front edge margin of each projection defines the free end. The first and second projections 1824, 1826 are generally parallel to one another and lie in separate, spaced apart planes. The base 1820 defines two fastener openings 1830 adjacent the upper and lower edge margins (e.g., vertically spaced apart) that are configured to align with the accessory attachment openings 30 on the web 22. The fastener openings 1830 may be threaded. Each of the first and second projections 1824, 1826 define a rod opening 1852 configured to receive the support rod 14. The rod openings 1852 are aligned (e.g., vertically aligned) and are configured to align with one of the rod couplers 50 (or accessory attachment openings 30) on the top or lower flanges 24, 26 of the support bracket 10. The opposite left and right edge margins of the base 1820 can each be sized and shaped to correspond to the size and shape of the non-structural component openings 28 so that when the reinforcement brace 1800 is connected to the support bracket 10, the base does not obstruct the non-structural component openings.

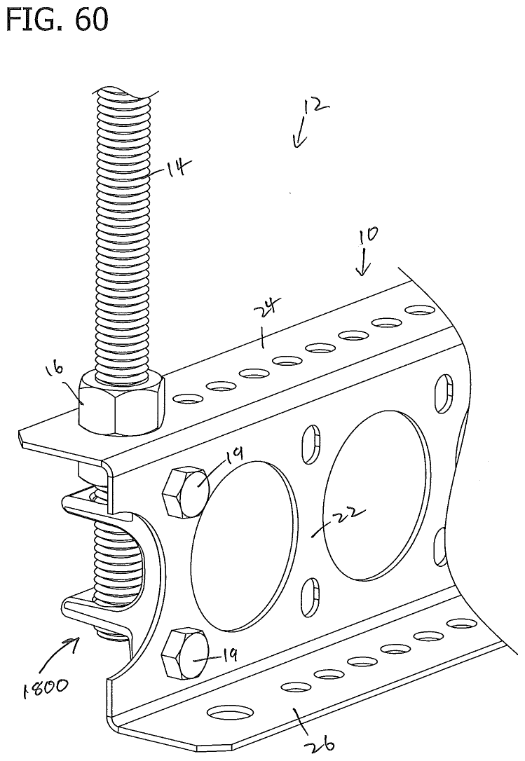

The reinforcement brace 1800 is configured to be attached to the web 22 of the support bracket 10 below or above one of the rod couplers 50 on either the top or lower flanges 24, 26. As shown in FIGS. 59 and 60, when the reinforcement brace 1800 is connected to the support bracket 10, the rear face of the base 1820 overlies and engages the rear face of the web 22 of the support bracket 10 and the rod openings 1852 are aligned (e.g., vertically aligned) with the one of the rod couplers 50 on the upper flange 24. Alternatively, the reinforcement brace 1800 can be attached to the front face of the web 22 such that the rod openings 1852 align (e.g., vertically align) with one of the rod couplers 50 on the lower flange 26. When the reinforcement brace 1800 is attached to the support bracket 10 between adjacent non-structural component openings 28, the left and right edge margins of the base 1820 do not obstruct the non-structural component openings. The fastener openings 1830 on the base 1820 align with the accessory attachment openings 30 on the web 22 such that a fastener 19 can be inserted therein to the secure the reinforcement brace 1800 to the support bracket 10. The fastener openings 1830 may be threaded to secure the fasteners 19 or nuts (not shown) can be used. When attached to the support bracket 10, the reinforcement brace 1800 provides an additional connection between the support bracket 10 and the support rod 14 and, specifically, connects the web 22 to the support rod 14 to stiffen the web 22 and inhibit bending thereof.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

Modifications and variations of the disclosed embodiments are possible without departing from the scope of the present disclosure defined in the appended claims. For example, where specific dimensions are given, it will be understood that they are exemplary only and other dimensions are possible.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A support bracket for a hanger assembly that supports one or more non-structural components in a building, the support bracket comprising:
a web having opposite upper and lower edge margins, opposite left and right edge margins, and a length extending between the left and right edge margins, the web defining at least one non-structural component opening configured to receive and support one of the non-structural components, the at least one non-structural component opening having a closed shape;
a first flange extending from the upper edge margin of the web in a first direction and configured to be attached to at least one support rod; and
a second flange extending from the lower edge margin of the web in a second direction opposite the first direction,
wherein the left and right edge margins of the web define partial openings, each of the partial openings having an open shape that is a segment of the closed shape of the at least one non-structural component opening.

2. The support bracket of claim 1, wherein the first flange defines left and right support rod openings adjacent the respective left and right edge margins of the web, wherein the left and right support rod openings are configured to receive respective left and right support rods.

3. The support bracket of claim 2, wherein the first flange defines accessory attachment openings spaced apart from one another along the first flange and between the left and right support rod openings.

4. The support bracket of claim 3, wherein the accessory attachment openings include first and second accessory attachment openings, wherein the first accessory attachment openings have an area less than an area of the second accessory attachment openings.

5. The support bracket of claim 4, wherein a plurality of the first accessary attachment openings are disposed between each adjacent ones of the second accessary attachment openings.

6. The support bracket of claim 4, wherein the second flange defines accessory attachment openings spaced apart from one another along the second flange.

7. The support bracket of claim 6, wherein the accessory attachment openings of the second flange include first and second accessory attachment openings, wherein the first accessory attachment openings have an area less than an area of the second accessory attachment openings.

8. The support bracket of claim 2, wherein the second flange defines accessory attachment openings spaced apart from one another along the second flange.

9. The support bracket of claim 1, wherein the web defines accessory attachment openings adjacent the at least one non-structural component opening.

10. The support bracket of claim 1, wherein the at least one non-structural component opening includes a plurality of non-structural component openings spaced apart from one another along the web.

11. The support bracket of claim 10, wherein the plurality of non-structural component openings have the same shape and size.

12. A support bracket for a hanger assembly that supports one or more non-structural components in a building, the support bracket comprising:
a web having opposite upper and lower edge margins, opposite left and right edge margins, and a length extending between the left and right edge margins, the web defining at least one non-structural component opening configured to receive and support one of the non-structural components;
a first flange extending from the upper edge margin of the web in a first direction, wherein the first flange defines left and right support rod openings adjacent the respective left and right edge margins of the web, wherein the left and right support rod openings are configured to receive respective left and right support rods; and
a second flange extending from the lower edge margin of the web in a second direction opposite the first direction,
wherein at least one of the first flange and the second flange defines accessory attachment openings spaced apart from one another along the respective one of the first and second flange.

13. The support bracket of claim 12, wherein the first flange defines the accessory attachment openings spaced apart from one another along the first flange and between the left and right support rod openings.

14. The support bracket of claim 13, wherein the accessory attachment openings of the first flange include first and second accessory attachment openings, wherein the first accessory attachment openings have an area less than an area of the second accessory attachment openings.

15. The support bracket of claim 14, wherein a plurality of the first accessary attachment openings are disposed between each adjacent ones of the second accessary attachment openings.

16. The support bracket of claim 13, wherein the second flange defines the accessory attachment openings spaced apart from one another along the second flange.

17. The support bracket of claim 16, wherein the accessory attachment openings of the second flange include first and second accessory attachment openings, wherein the first accessory attachment openings have an area less than an area of the second accessory attachment openings.

18. The support bracket of claim 13, wherein the second flange defines the accessory attachment openings spaced apart from one another along the second flange.

19. The support bracket of claim 12, the at least one structural component opening has a closed shape, wherein the left and right edge margins of the web define partial openings, each of the partial openings having an open shape that is a segment of the closed shape of the at least one structural component opening.

20. The support bracket of claim 12, wherein the at least one structural component opening includes a plurality of structural component openings spaced apart from one another along the web.
